(19) United States
(12) Patent Application Publication
(10) Pub. No.: US 2024/0303858 A1
(43) Pub. Date: Sep. 12, 2024

(54) METHODS AND APPARATUS FOR REDUCING MULTIPATH ARTIFACTS FOR A CAMERA SYSTEM OF A MOBILE ROBOT

(71) Applicant: Boston Dynamics, Inc., Waltham, MA (US)

(72) Inventors: Matthew Turpin, Newton, MA (US); Andrew Hoelscher, Somerville, MA (US); Lukas Merkle, Cambridge, MA (US)

(73) Assignee: Boston Dynamics, Inc., Waltham, MA (US)

(21) Appl. No.: 18/545,559

(22) Filed: Dec. 19, 2023

Related U.S. Application Data
(60) Provisional application No. 63/451,145, filed on Mar. 9, 2023.

(51) Int. Cl. G06T 7/73; G06T 7/13; G06T 7/521; G06T 7/55

(52) U.S. Cl. CPC G06T 7/74; G06T 7/13; G06T 7/521; G06T 7/55; G06T 2207/10028; G06T 2207/20081

(57) ABSTRACT

Methods and apparatus for determining a pose of an object sensed by a camera system of a mobile robot are described. The method includes acquiring, using the camera system, a first image of the object from a first perspective and a second image of the object from a second perspective, and determining, by a processor of the camera system, a pose of the object based, at least in part, on a first set of sparse features associated with the object detected in the first image and a second set of sparse features associated with the object detected in the second image.

### CROSS-REFERENCE TO RELATED APPLICATIONS

This application claims the benefit under 35 U.S.C. § 119(e) to U.S. Provisional Patent Application No. 63/451,145, filed Mar. 9, 2023, and titled, “METHODS AND APPARATUS FOR REDUCING MULTIPATH ARTIFACTS FOR A CAMERA SYSTEM OF A MOBILE ROBOT,” the contents of which is incorporated herein by reference in its entirety.

### FIELD OF THE INVENTION

This disclosure relates to techniques for object pose estimation using a camera system of a mobile robot.

### BACKGROUND

A robot is generally defined as a reprogrammable and multifunctional manipulator designed to move material, parts, tools, and/or specialized devices (e.g., via variable programmed motions) for performing tasks. Robots may include manipulators that are physically anchored (e.g., industrial robotic arms), mobile devices that move throughout an environment (e.g., using legs, wheels, or traction-based mechanisms), or some combination of one or more manipulators and one or more mobile devices. Robots are currently used in a variety of industries, including, for example, manufacturing, warehouse logistics, transportation, hazardous environments, exploration, and healthcare.

### SUMMARY

Robots may be configured to grasp objects (e.g., boxes) and move them from one location to another using, for example, a robotic arm with a vacuum-based gripper attached thereto. For instance, the robotic arm may be positioned such that one or more suction cups of the gripper are in contact with (or are near) a face of a target object to be grasped. An on-board vacuum system may then be activated to use suction to adhere the object to the gripper, thereby grasping the object.

To enable the robot to position the gripper with a pose (e.g., position and orientation) capable of effectively grasping the target object, the pose of the target object to be grasped in three-dimensional (3D) space may be estimated. The robot may have an onboard camera system that includes one or more camera modules configured to capture images of the environment of the robot, including potential objects to be grasped. Each camera module may also include one or more depth sensors configured to sense depth information about objects in the environment. The images captured by the camera system may be processed to identify features that correspond to the objects in the environment, and the pose of the object may be estimated by projecting the identified object features into 3D space using the sensed depth information.

Indirect time-of-flight sensors may be used to detect the depth information by emitting amplitude-modulated signals and measuring the phase of signals reflected from objects in the environment. In certain environments that include multiple interacting objects, such as a truck interior, the emitted signals may be reflected from multiple surfaces thereby distorting the measured phase. When used to project features from images into 3D space, the distorted phase information caused by so-called “multi-path” artifacts, may result in the estimate of the object pose being incorrect in 3D space. For instance, multi-path artifacts may cause object pose estimates to appear farther from the camera module than the actual location of the object in the environment.

Errors in object pose estimates due, at least in part, to multi-path artifacts, reduces the effectiveness of the robot in being able to effectively grasp target objects in the environment. For instance, incorrect estimates of the object poses may lead to a number of effects including, but not limited to, unintended grasping of multiple objects, poor grasp quality on a target object, the inability to grasp smaller objects, and collision of the robot arm and/or gripper with objects in the environment. Some embodiments of the present disclosure relate to techniques for reducing multi-path artifacts by reconstructing object face pose estimates based on sparse features extracted from multiple images of the object captured from different perspectives.

In some embodiments, the invention features a method of determining a pose of an object sensed by a camera system of a mobile robot. The method includes acquiring, using the camera system, a first image of the object from a first perspective and a second image of the object from a second perspective, and determining, by a processor of the camera system, a pose of the object based, at least in part, on a first set of sparse features associated with the object detected in the first image and a second set of sparse features associated with the object detected in the second image.

In one aspect, the method further includes processing the first image and the second image with at least one machine learning model to detect the first set of sparse features and the second set of sparse features, respectively. In another aspect, the at least one machine model is configured to output a location and a confidence value associated with each sparse feature in the first set and the second set, and determining the pose of the object based, at least in part, on the first set of sparse features and the second set of sparse features is performed only when each sparse feature in the first set and the second set is associated with a confidence value above a threshold value.

In another aspect, the camera system includes a first camera module and second camera module, the first camera module and the second camera module being separated by a first distance and having overlapping fields-of-view, the first image is acquired using the first camera module, and the second image is acquired using the second camera module. In another aspect, a second distance from the first camera module to the object is between one to five times the first distance. In another aspect, the first camera module includes a first depth sensor configured to acquire first depth information associated with the first image, and the second camera module includes a second depth sensor configured to acquire second depth information associated with the second image. In another aspect, each of the first set of sparse features and the second set of sparse features include locations of a plurality of points associated with the object in the first image and the second image, respectively. In another aspect, the plurality of points associated with the object comprise a plurality of corners of the object. In another aspect, the object is a box and the plurality of points associated with the object comprise corners of a face of the box.

In another aspect, the method further includes projecting the sparse features in the first set into a 3-dimensional (3D) space based on the first depth information to produce a first initial 3D estimate of the object, and projecting the sparse features in the second set into the 3D space based on the second depth information to produce a second 3D estimate of the object. In another aspect, the method further includes generating a refined 3D estimate of the object based on the first initial 3D estimate, the second 3D estimate and a cost function that includes a plurality of error terms, the plurality of error terms including at least one reprojection error term. In another aspect, each sparse feature in the first set and the second set has a detected location in 2D image space, and generating the refined 3D estimate includes reprojecting each sparse feature from the 3D space into the 2D image space to determine a corresponding reprojected location for each sparse feature, and defining a vector from the reprojected location of each sparse feature to its corresponding detected location in 2D image space, wherein the cost function includes a reprojection error term for each sparse feature corresponding to a length of the defined vector for the sparse feature. In another aspect, the plurality of error terms includes at least one pitch error term. In another aspect, generating the refined 3D estimate comprises performing a least squares optimization of the cost function. In another aspect, the cost function is an arctan cost function. In another aspect, each of the first depth sensor and the second depth sensor is an indirect time-of-flight sensor.

In another aspect, the method further includes determining whether a location of at least one sparse feature in the first set is inaccurate due to an occlusion of the object by another object sensed by the camera system, and determining the pose of the object based, at least in part, on the first set of sparse features and the second set of sparse features is performed only when it is not determined that the location of the at least one sparse feature in the first set is inaccurate due to an occlusion of the object by another object sensed by the camera system. In another aspect, determining whether a location of at least one sparse feature in the first set is inaccurate due to an occlusion of the object by another object sensed by the camera system includes acquiring, using the camera system, depth information corresponding to the first image of the object, and determining that the another object is causing an occlusion of the object in the first image when a histogram of values in the depth information has a bimodal distribution. In another aspect, the method further includes determining a standard deviation of the values of the depth information, and determining that the histogram of the values in the depth information has a bimodal distribution when the standard deviation is greater than a threshold value.

In another aspect, the method further includes determining whether a location of at least one sparse feature in the first set is inaccurate due to a partial occlusion of the object by another object sensed by the camera system, and identifying one or more valid sparse features in the first set of sparse features, the one or more valid sparse features not being occluded in the first image, wherein determining the pose of the object is further based, at least in part, on the one or more valid sparse features in the first set of sparse features and the second set of sparse features associated with the object detected in the second image. In another aspect, identifying the one or more valid sparse features includes performing pose optimizations of different valid combinations of sparse features to determine combination candidates, filtering the combination candidates based on one or more thresholds to generate one or more acceptable combination candidates, ranking the acceptable candidates based on one or more heuristics, and identifying the one or more valid sparse features based, at least in part, on the acceptable candidate having a highest rank.

In some embodiments, the invention features a mobile robot. The mobile robot includes a camera system and at least one processor. The at least one processor is programmed to control the camera system to capture a first image of an object in an environment of the mobile robot from a first perspective and capture a second image of the object from a second perspective, and determine a pose of the object based, at least in part, on a first set of sparse features associated with the object detected in the first image and a second set of sparse features associated with the object detected in the second image.

In one aspect, the at least one processor is further programmed to process the first image and the second image with at least one machine learning model to detect the first set of sparse features and the second set of sparse features, respectively. In another aspect, the at least one machine model is configured to output a location and a confidence value associated with each sparse feature in the first set and the second set, and determining the pose of the object based, at least in part, on the first set of sparse features and the second set of sparse features is performed only when each sparse feature in the first set and the second set is associated with a confidence value above a threshold value.

In another aspect, the camera system includes a first camera module and second camera module, the first camera module and the second camera module being separated by a first distance and having overlapping fields-of-view, the first image is acquired using the first camera module, and the second image is acquired using the second camera module. In another aspect, a second distance from the first camera module to the object is between one to five times the first distance. In another aspect, the first camera module includes a first depth sensor configured to acquire first depth information associated with the first image, and the second camera module includes a second depth sensor configured to acquire second depth information associated with the second image. In another aspect, each of the first set of sparse features and the second set of sparse features include locations of a plurality of points associated with the object in the first image and the second image, respectively. In another aspect, the plurality of points associated with the object comprise a plurality of corners of the object. In another aspect, the object is a box and the plurality of points associated with the object comprise corners of a face of the box.

In another aspect, the at least one processor is further programmed to project the sparse features in the first set into a 3-dimensional (3D) space based on the first depth information to produce a first initial 3D estimate of the object, and project the sparse features in the second set into the 3D space based on the second depth information to produce a second 3D estimate of the object. In another aspect, the at least one processor is further programmed to generate a refined 3D estimate of the object based on the first initial 3D estimate, the second 3D estimate and a cost function that includes a plurality of error terms, the plurality of error terms including at least one reprojection error term. In another aspect, each sparse feature in the first set and the second set has a detected location in 2D image space, and generating the refined 3D estimate includes reprojecting each sparse feature from the 3D space into the 2D image space to determine a corresponding reprojected location for each sparse feature, and defining a vector from the reprojected location of each sparse feature to its corresponding detected location in 2D image space, wherein the cost function includes a reprojection error term for each sparse feature corresponding to a length of the defined vector for the sparse feature. In another aspect, the plurality of error terms includes at least one pitch error term. In another aspect, generating the refined 3D estimate comprises performing a least squares optimization of the cost function. In another aspect, the cost function is an arctan cost function. In another aspect, each of the first depth sensor and the second depth sensor is an indirect time-of-flight sensor.

In another aspect, the at least one processor is further programmed to determine whether a location of at least one sparse feature in the first set is inaccurate due to an occlusion of the object by another object sensed by the camera system, and determine the pose of the object based, at least in part, on the first set of sparse features and the second set of sparse features is performed only when it is not determined that the location of the at least one sparse feature in the first set is inaccurate due to an occlusion of the object by another object sensed by the camera system. In another aspect, determining whether a location of at least one sparse feature in the first set is inaccurate due to an occlusion of the object by another object sensed by the camera system includes acquiring, using the camera system, depth information corresponding to the first image of the object, and determining that the another object is causing an occlusion of the object in the first image when a histogram of values in the depth information has a bimodal distribution. In another aspect, the at least one processor is further programmed to determine a standard deviation of the values of the depth information, and determine that the histogram of the values in the depth information has a bimodal distribution when the standard deviation is greater than a threshold value.

In another aspect, the at least one processor is further programmed to determine whether a location of at least one sparse feature in the first set is inaccurate due to a partial occlusion of the object by another object sensed by the camera system, and identify one or more valid sparse features in the first set of sparse features, the one or more valid sparse features not being occluded in the first image, wherein determining the pose of the object is further based, at least in part, on the one or more valid sparse features in the first set of sparse features and the second set of sparse features associated with the object detected in the second image. In another aspect, identifying the one or more valid sparse features includes performing pose optimizations of different valid combinations of sparse features to determine combination candidates, filtering the combination candidates based on one or more thresholds to generate one or more acceptable combination candidates, ranking the acceptable candidates based on one or more heuristics, and identifying the one or more valid sparse features based, at least in part, on the acceptable candidate having a highest rank.

In some embodiments, the invention features a non-transitory computer readable medium encoded with a plurality of instructions that, when executed by a computer processor, perform a method. The method includes receiving from a camera system, a first image of the object captured from a first perspective and a second image of the object captured from a second perspective, and determining, by at least one processor of the camera system, a pose of the object based, at least in part, on a first set of sparse features associated with the object detected in the first image and a second set of sparse features associated with the object detected in the second image.

In one aspect, the method further includes processing the first image and the second image with at least one machine learning model to detect the first set of sparse features and the second set of sparse features, respectively. In another aspect, the at least one machine model is configured to output a location and a confidence value associated with each sparse feature in the first set and the second set, and determining the pose of the object based, at least in part, on the first set of sparse features and the second set of sparse features is performed only when each sparse feature in the first set and the second set is associated with a confidence value above a threshold value.

In another aspect, the camera system includes a first camera module and second camera module, the first camera module and the second camera module being separated by a first distance and having overlapping fields-of-view, the first image is acquired using the first camera module, and the second image is acquired using the second camera module. In another aspect, a second distance from the first camera module to the object is between one to five times the first distance. In another aspect, the first camera module includes a first depth sensor configured to acquire first depth information associated with the first image, and the second camera module includes a second depth sensor configured to acquire second depth information associated with the second image. In another aspect, each of the first set of sparse features and the second set of sparse features include locations of a plurality of points associated with the object in the first image and the second image, respectively. In another aspect, the plurality of points associated with the object comprise a plurality of corners of the object. In another aspect, the object is a box and the plurality of points associated with the object comprise corners of a face of the box.

In another aspect, the method further includes projecting the sparse features in the first set into a 3-dimensional (3D) space based on the first depth information to produce a first initial 3D estimate of the object, and projecting the sparse features in the second set into the 3D space based on the second depth information to produce a second 3D estimate of the object. In another aspect, the method further includes generating a refined 3D estimate of the object based on the first initial 3D estimate, the second 3D estimate and a cost function that includes a plurality of error terms, the plurality of error terms including at least one reprojection error term. In another aspect, each sparse feature in the first set and the second set has a detected location in 2D image space, and generating the refined 3D estimate includes reprojecting each sparse feature from the 3D space into the 2D image space to determine a corresponding reprojected location for each sparse feature, and defining a vector from the reprojected location of each sparse feature to its corresponding detected location in 2D image space, wherein the cost function includes a reprojection error term for each sparse feature corresponding to a length of the defined vector for the sparse feature. In another aspect, the plurality of error terms includes at least one pitch error term. In another aspect, generating the refined 3D estimate comprises performing a least squares optimization of the cost function. In another aspect, the cost function is an arctan cost function. In another aspect, the first depth sensor and the second depth sensor is an indirect time-of-flight sensor.

In another aspect, the method further includes determining whether a location of at least one sparse feature in the first set is inaccurate due to an occlusion of the object by another object sensed by the camera system, and determining the pose of the object based, at least in part, on the first set of sparse features and the second set of sparse features is performed only when it is not determined that the location of the at least one sparse feature in the first set is inaccurate due to an occlusion of the object by another object sensed by the camera system. In another aspect, determining whether a location of at least one sparse feature in the first set is inaccurate due to an occlusion of the object by another object sensed by the camera system includes acquiring, using the camera system, depth information corresponding to the first image of the object, and determining that the another object is causing an occlusion of the object in the first image when a histogram of values in the depth information has a bimodal distribution. In another aspect, the method further includes determining a standard deviation of the values of the depth information, and determining that the histogram of the values in the depth information has a bimodal distribution when the standard deviation is greater than a threshold value.

In another aspect, the method further includes determining whether a location of at least one sparse feature in the first set is inaccurate due to a partial occlusion of the object by another object sensed by the camera system, and identifying one or more valid sparse features in the first set of sparse features, the one or more valid sparse features not being occluded in the first image, wherein determining the pose of the object is further based, at least in part, on the one or more valid sparse features in the first set of sparse features and the second set of sparse features associated with the object detected in the second image. In another aspect, identifying the one or more valid sparse features includes performing pose optimizations of different valid combinations of sparse features to determine combination candidates, filtering the combination candidates based on one or more thresholds to generate one or more acceptable combination candidates, ranking the acceptable candidates based on one or more heuristics, and identifying the one or more valid sparse features based, at least in part, on the acceptable candidate having a highest rank.

### BRIEF DESCRIPTION OF DRAWINGS

The advantages of the invention, together with further advantages, may be better understood by referring to the following description taken in conjunction with the accompanying drawings. The drawings are not necessarily to scale, and emphasis is instead generally placed upon illustrating the principles of the invention.

FIGS. 1A and 1B are perspective views of a robot, according to an illustrative embodiment of the invention.

FIG. 2A depicts robots performing different tasks within a warehouse environment, according to an illustrative embodiment of the invention.

FIG. 2B depicts a robot unloading boxes from a truck and placing them on a conveyor belt, according to an illustrative embodiment of the invention.

FIG. 2C depicts a robot performing an order building task in which the robot places boxes onto a pallet, according to an illustrative embodiment of the invention.

FIG. 3 is a perspective view of a robot, according to an illustrative embodiment of the invention.

FIG. 4A schematically illustrates a multi-path effect that may cause distortion in depth measurements in some environments in which a robotic device may operate.

FIG. 4B schematically illustrates how perceived objects may differ from their actual positions in the world due to pose estimations distorted by the multi-path effect shown in FIG. 4A.

FIG. 4C schematically illustrates example problems with robotic device operation that may occur when multi-path artifacts are not taken into consideration.

FIG. 5 schematically illustrates a process for generating a refined 3D estimate of an object that takes into consideration multi-path artifacts, according to an illustrative embodiment of the invention.

FIG. 6 is a flowchart of a process for determining a pose of an object in an environment of a robotic device, according to an illustrative embodiment of the invention.

FIGS. 7A-7C schematically illustrate a process for determining whether a second object in the environment of a robotic device occludes at least a portion of a first object being detected by a camera system of the robotic device, according to an illustrative embodiment of the invention.

FIGS. 8A and 8B illustrate detection of a sparse feature with low confidence as determined by a trained machine learning model, according to an illustrative embodiment of the invention.

FIG. 9 is a flowchart of a process for performing a multi-path correction to generate a refined 3D estimate of an object, according to an illustrative embodiment of the invention.

FIG. 10 schematically illustrates determination of a reprojection error of a sparse feature projected from 3D space into 2D image space, according to an illustrative embodiment of the invention.

FIG. 11 illustrates an example configuration of a robotic device, according to an illustrative embodiment of the invention.

FIG. 12 is a flowchart of a first process for performing a multi-path correction process based on incomplete sparse feature information, according to an illustrative embodiment of the invention.

FIGS. 13A-13B are schematic representations of a scenario in which at least one corner of an object is occluded in a camera view, according to an illustrative embodiment of the invention.

FIGS. 14A-D schematically illustrate results of performing a multi-path correction using different combinations of sparse features, according to an illustrative embodiment of the invention.

FIG. 15 is a flowchart of a second process for performing a multi-path correction process based on incomplete sparse feature information, according to an illustrative embodiment of the invention.

FIGS. 16A-16C are schematic representations of performing the second process for performing a multi-path correction process, according to an illustrative embodiment of the invention.

FIG. 17 is a flowchart of a third process for performing a multi-path correction process based on incomplete sparse feature information, according to an illustrative embodiment of the invention.

### DETAILED DESCRIPTION

Robots tasked with grasping an object (e.g., a box) rely on an accurate estimate of the object pose to be able to place its gripper in a position that enables grasping the object while avoiding collisions with other objects in the environment. The object pose may be estimated based on one or more images of the environment and depth information used to determine the distance of each of the pixels in the image(s). When the depth information is sensed using indirect time-of-flight sensors, the distance determined for each of the pixels in the image(s) may be inaccurate (e.g., underestimated or overestimated) when the environment includes multiple interacting surfaces. Such multi-path artifacts may cause errors in the depth information, which is used to estimate object pose, resulting in discrepancies between the estimated object pose and the actual object pose that lead to sub-optimal performance of the robot when attempting to grasp objects. To this end, some embodiments of the present disclosure relate to techniques for mitigating the effect of multi-path artifacts to improve the estimation of object pose sensed by a perception system of a robot.

Robots can be configured to perform a number of tasks in an environment in which they are placed. Exemplary tasks may include interacting with objects and/or elements of the environment. Notably, robots are becoming popular in warehouse and logistics operations. Before robots were introduced to such spaces, many operations were performed manually. For example, a person might manually unload boxes from a truck onto one end of a conveyor belt, and a second person at the opposite end of the conveyor belt might organize those boxes onto a pallet. The pallet might then be picked up by a forklift operated by a third person, who might drive to a storage area of the warehouse and drop the pallet for a fourth person to remove the individual boxes from the pallet and place them on shelves in a storage area. Some robotic solutions have been developed to automate many of these functions. Such robots may either be specialist robots (i.e., designed to perform a single task or a small number of related tasks) or generalist robots (i.e., designed to perform a wide variety of tasks). To date, both specialist and generalist warehouse robots have been associated with significant limitations.

For example, because a specialist robot may be designed to perform a single task (e.g., unloading boxes from a truck onto a conveyor belt), while such specialized robots may be efficient at performing their designated task, they may be unable to perform other related tasks. As a result, either a person or a separate robot (e.g., another specialist robot designed for a different task) may be needed to perform the next task(s) in the sequence. As such, a warehouse may need to invest in multiple specialized robots to perform a sequence of tasks, or may need to rely on a hybrid operation in which there are frequent robot-to-human or human-to-robot handoffs of objects.

In contrast, while a generalist robot may be designed to perform a wide variety of tasks (e.g., unloading, palletizing, transporting, depalletizing, and/or storing), such generalist robots may be unable to perform individual tasks with high enough efficiency or accuracy to warrant introduction into a highly streamlined warehouse operation. For example, while mounting an off-the-shelf robotic manipulator onto an off-the-shelf mobile robot might yield a system that could, in theory, accomplish many warehouse tasks, such a loosely integrated system may be incapable of performing complex or dynamic motions that require coordination between the manipulator and the mobile base, resulting in a combined system that is inefficient and inflexible.

Typical operation of such a system within a warehouse environment may include the mobile base and the manipulator operating sequentially and (partially or entirely) independently of each other. For example, the mobile base may first drive toward a stack of boxes with the manipulator powered down. Upon reaching the stack of boxes, the mobile base may come to a stop, and the manipulator may power up and begin manipulating the boxes as the base remains stationary. After the manipulation task is completed, the manipulator may again power down, and the mobile base may drive to another destination to perform the next task.

In such systems, the mobile base and the manipulator may be regarded as effectively two separate robots that have been joined together. Accordingly, a controller associated with the manipulator may not be configured to share information with, pass commands to, or receive commands from a separate controller associated with the mobile base. As such, such a poorly integrated mobile manipulator robot may be forced to operate both its manipulator and its base at suboptimal speeds or through suboptimal trajectories, as the two separate controllers struggle to work together. Additionally, while certain limitations arise from an engineering perspective, additional limitations must be imposed to comply with safety regulations. For example, if a safety regulation requires that a mobile manipulator must be able to be completely shut down within a certain period of time when a human enters a region within a certain distance of the robot, a loosely integrated mobile manipulator robot may not be able to act sufficiently quickly to ensure that both the manipulator and the mobile base (individually and in aggregate) do not threaten the human. To ensure that such loosely integrated systems operate within required safety constraints, such systems are forced to operate at even slower speeds or to execute even more conservative trajectories than those limited speeds and trajectories as already imposed by the engineering problem. As such, the speed and efficiency of generalist robots performing tasks in warehouse environments to date have been limited.

In view of the above, a highly integrated mobile manipulator robot with system-level mechanical design and holistic control strategies between the manipulator and the mobile base may provide certain benefits in warehouse and/or logistics operations. Such an integrated mobile manipulator robot may be able to perform complex and/or dynamic motions that are unable to be achieved by conventional, loosely integrated mobile manipulator systems. As a result, this type of robot may be well suited to perform a variety of different tasks (e.g., within a warehouse environment) with speed, agility, and efficiency.

### Example Robot Overview

In this section, an overview of some components of one embodiment of a highly integrated mobile manipulator robot configured to perform a variety of tasks is provided to explain the interactions and interdependencies of various subsystems of the robot. Each of the various subsystems, as well as control strategies for operating the subsystems, are described in further detail in the following sections.

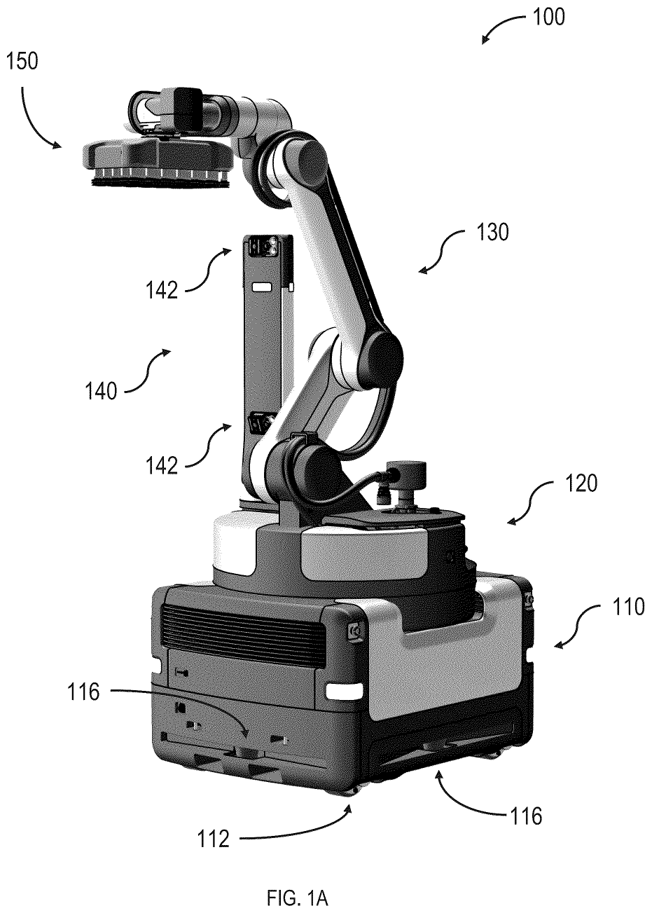

FIGS. 1A and 1B are perspective views of a robot 100, according to an illustrative embodiment of the invention. The robot 100 includes a mobile base 110 and a robotic arm 130. The mobile base 110 includes an omnidirectional drive system that enables the mobile base to translate in any direction within a horizontal plane as well as rotate about a vertical axis perpendicular to the plane. Each wheel 112 of the mobile base 110 is independently steerable and independently drivable. The mobile base 110 additionally includes a number of distance sensors 116 that assist the robot 100 in safely moving about its environment. The robotic arm 130 is a 6 degree of freedom (6-DOF) robotic arm including three pitch joints and a 3-DOF wrist. An end effector 150 is disposed at the distal end of the robotic arm 130. The robotic arm 130 is operatively coupled to the mobile base 110 via a turntable 120, which is configured to rotate relative to the mobile base 110. In addition to the robotic arm 130, a perception mast 140 is also coupled to the turntable 120, such that rotation of the turntable 120 relative to the mobile base 110 rotates both the robotic arm 130 and the perception mast 140. The robotic arm 130 is kinematically constrained to avoid collision with the perception mast 140. The perception mast 140 is additionally configured to rotate relative to the turntable 120, and includes a number of perception modules 142 configured to gather information about one or more objects in the robot's environment. The integrated structure and system-level design of the robot 100 enable fast and efficient operation in a number of different applications, some of which are provided below as examples.

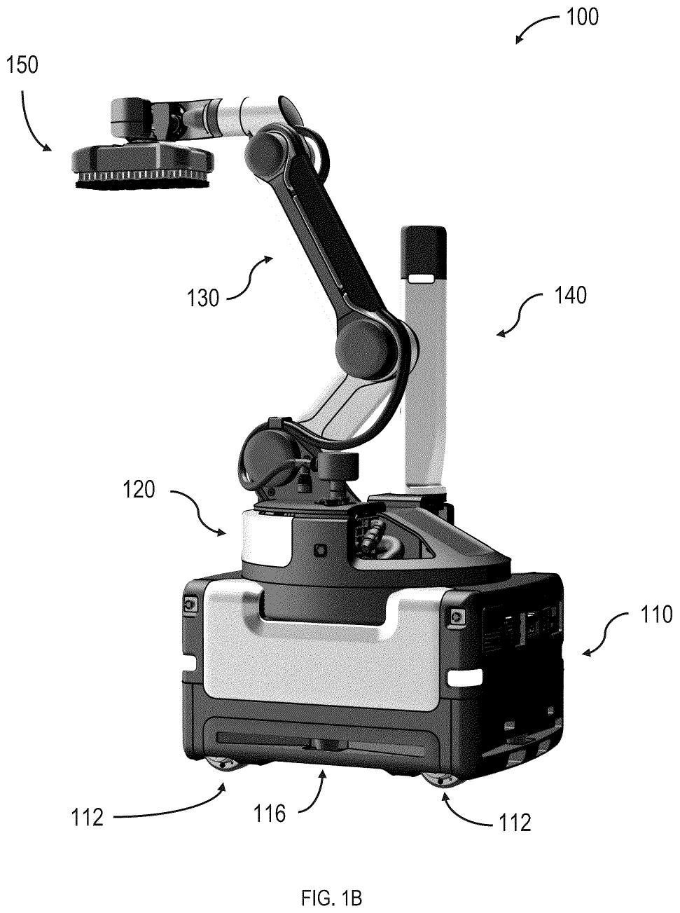

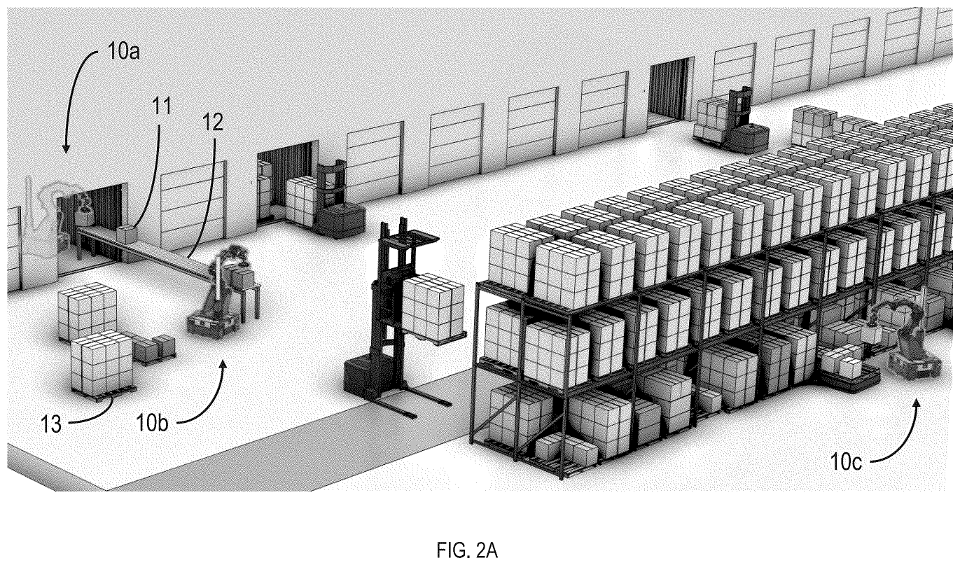

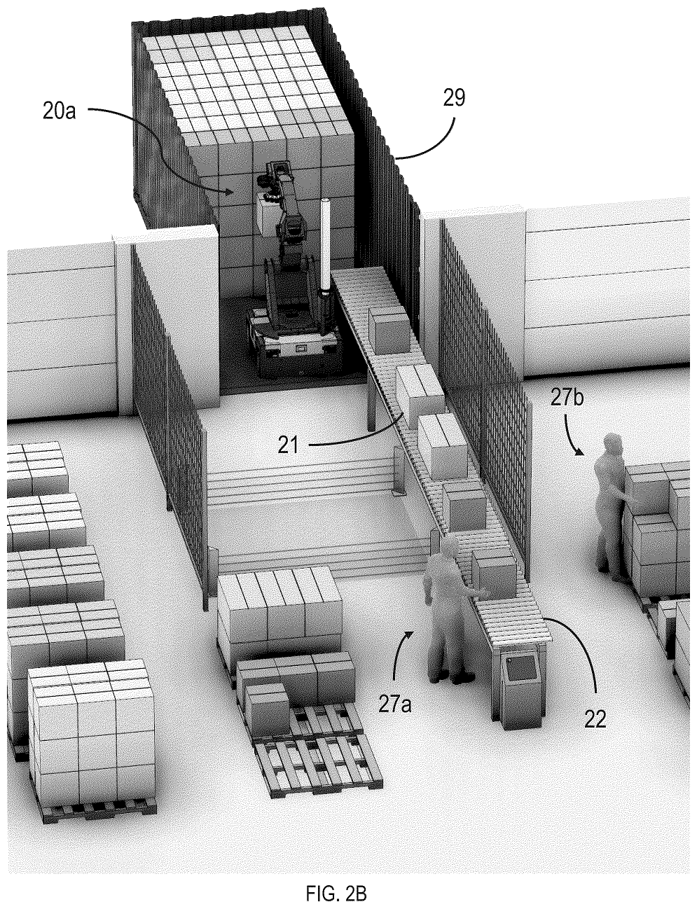

FIG. 2A depicts robots 10a, 10b, and 10c performing different tasks within a warehouse environment. A first robot 10a is inside a truck (or a container), moving boxes 11 from a stack within the truck onto a conveyor belt 12 (this particular task will be discussed in greater detail below in reference to FIG. 2B). At the opposite end of the conveyor belt 12, a second robot 10b organizes the boxes 11 onto a pallet 13. In a separate area of the warehouse, a third robot 10c picks boxes from shelving to build an order on a pallet (this particular task will be discussed in greater detail below in reference to FIG. 2C). The robots 10a, 10b, and 10c can be different instances of the same robot or similar robots. Accordingly, the robots described herein may be understood as specialized multi-purpose robots, in that they are designed to perform specific tasks accurately and efficiently, but are not limited to only one or a small number of tasks.

FIG. 2B depicts a robot 20a unloading boxes 21 from a truck 29 and placing them on a conveyor belt 22. In this box picking application (as well as in other box picking applications), the robot 20a repetitiously picks a box, rotates, places the box, and rotates back to pick the next box. Although robot 20a of FIG. 2B is a different embodiment from robot 100 of FIGS. 1A and 1B, referring to the components of robot 100 identified in FIGS. 1A and 1B will ease explanation of the operation of the robot 20a in FIG. 2B.

During operation, the perception mast of robot 20a (analogous to the perception mast 140 of robot 100 of FIGS. 1A and 1B) may be configured to rotate independently of rotation of the turntable (analogous to the turntable 120) on which it is mounted to enable the perception modules (akin to perception modules 142) mounted on the perception mast to capture images of the environment that enable the robot 20a to plan its next movement while simultaneously executing a current movement. For example, while the robot 20a is picking a first box from the stack of boxes in the truck 29, the perception modules on the perception mast may point at and gather information about the location where the first box is to be placed (e.g., the conveyor belt 22). Then, after the turntable rotates and while the robot 20a is placing the first box on the conveyor belt, the perception mast may rotate (relative to the turntable) such that the perception modules on the perception mast point at the stack of boxes and gather information about the stack of boxes, which is used to determine the second box to be picked. As the turntable rotates back to allow the robot to pick the second box, the perception mast may gather updated information about the area surrounding the conveyor belt. In this way, the robot 20a may parallelize tasks which may otherwise have been performed sequentially, thus enabling faster and more efficient operation.

Also of note in FIG. 2B is that the robot 20a is working alongside humans (e.g., workers 27a and 27b). Given that the robot 20a is configured to perform many tasks that have traditionally been performed by humans, the robot 20a is designed to have a small footprint, both to enable access to areas designed to be accessed by humans, and to minimize the size of a safety field around the robot (e.g., into which humans are prevented from entering and/or which are associated with other safety controls, as explained in greater detail below).

FIG. 2C depicts a robot 30a performing an order building task, in which the robot 30a places boxes 31 onto a pallet 33. In FIG. 2C, the pallet 33 is disposed on top of an autonomous mobile robot (AMR) 34, but it should be appreciated that the capabilities of the robot 30a described in this example apply to building pallets not associated with an AMR. In this task, the robot 30a picks boxes 31 disposed above, below, or within shelving 35 of the warehouse and places the boxes on the pallet 33. Certain box positions and orientations relative to the shelving may suggest different box picking strategies. For example, a box located on a low shelf may simply be picked by the robot by grasping a top surface of the box with the end effector of the robotic arm (thereby executing a “top pick”). However, if the box to be picked is on top of a stack of boxes, and there is limited clearance between the top of the box and the bottom of a horizontal divider of the shelving, the robot may opt to pick the box by grasping a side surface (thereby executing a “face pick”).

To pick some boxes within a constrained environment, the robot may need to carefully adjust the orientation of its arm to avoid contacting other boxes or the surrounding shelving. For example, in a typical “keyhole problem”, the robot may only be able to access a target box by navigating its arm through a small space or confined area (akin to a keyhole) defined by other boxes or the surrounding shelving. In such scenarios, coordination between the mobile base and the arm of the robot may be beneficial. For instance, being able to translate the base in any direction allows the robot to position itself as close as possible to the shelving, effectively extending the length of its arm (compared to conventional robots without omnidirectional drive which may be unable to navigate arbitrarily close to the shelving). Additionally, being able to translate the base backwards allows the robot to withdraw its arm from the shelving after picking the box without having to adjust joint angles (or minimizing the degree to which joint angles are adjusted), thereby enabling a simple solution to many keyhole problems.

The tasks depicted in FIGS. 2A-2C are only a few examples of applications in which an integrated mobile manipulator robot may be used, and the present disclosure is not limited to robots configured to perform only these specific tasks. For example, the robots described herein may be suited to perform tasks including, but not limited to: removing objects from a truck or container; placing objects on a conveyor belt; removing objects from a conveyor belt; organizing objects into a stack; organizing objects on a pallet; placing objects on a shelf, organizing objects on a shelf, removing objects from a shelf, picking objects from the top (e.g., performing a “top pick”); picking objects from a side (e.g., performing a “face pick”); coordinating with other mobile manipulator robots; coordinating with other warehouse robots (e.g., coordinating with AMRs); coordinating with humans; and many other tasks.

### Example Robotic Arm

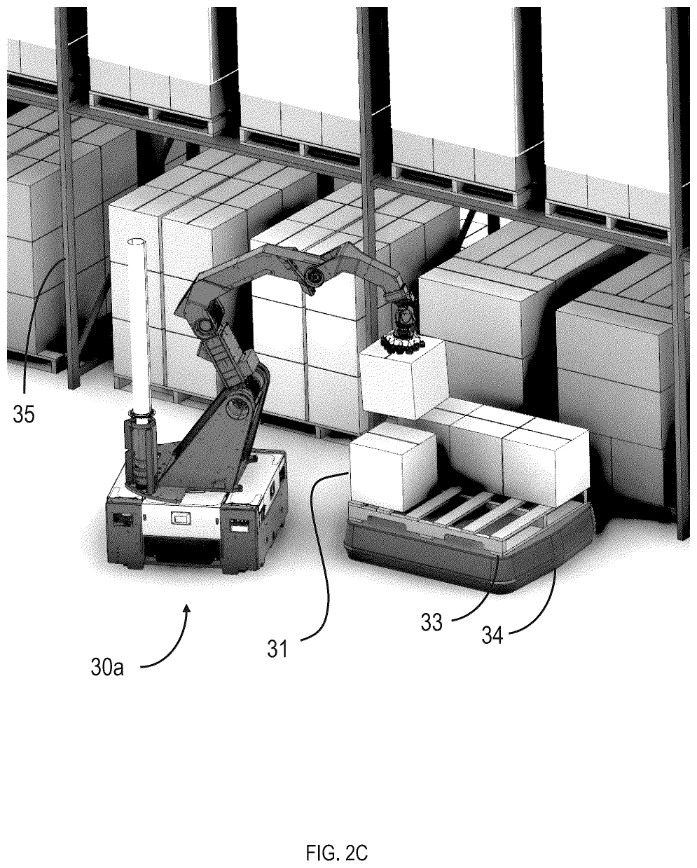

FIG. 3 is a perspective view of a robot 400, according to an illustrative embodiment of the invention. The robot 400 includes a mobile base 410 and a turntable 420 rotatably coupled to the mobile base. A robotic arm 430 is operatively coupled to the turntable 420, as is a perception mast 440. The perception mast 440 includes an actuator 444 configured to enable rotation of the perception mast 440 relative to the turntable 420 and/or the mobile base 410, so that a direction of the perception modules 442 of the perception mast may be independently controlled.

The robotic arm 430 of FIG. 3 is a 6-DOF robotic arm. When considered in conjunction with the turntable 420 (which is configured to yaw relative to the mobile base about a vertical axis parallel to the Z axis), the arm/turntable system may be considered a 7-DOF system. The 6-DOF robotic arm 430 includes three pitch joints 432, 434, and 436, and a 3-DOF wrist 438 which, in some embodiments, may be a spherical 3-DOF wrist.

Starting at the turntable 420, the robotic arm 430 includes a turntable offset 422, which is fixed relative to the turntable 420. A distal portion of the turntable offset 422 is rotatably coupled to a proximal portion of a first link 433 at a first joint 432. A distal portion of the first link 433 is rotatably coupled to a proximal portion of a second link 435 at a second joint 434. A distal portion of the second link 435 is rotatably coupled to a proximal portion of a third link 437 at a third joint 436. The first, second, and third joints 432, 434, and 436 are associated with first, second, and third axes 432a, 434a, and 436a, respectively.

The first, second, and third joints 432, 434, and 436 are additionally associated with first, second, and third actuators (not labeled) which are configured to rotate a link about an axis. Generally, the nth actuator is configured to rotate the nth link about the nth axis associated with the nth joint. Specifically, the first actuator is configured to rotate the first link 433 about the first axis 432a associated with the first joint 432, the second actuator is configured to rotate the second link 435 about the second axis 434a associated with the second joint 434, and the third actuator is configured to rotate the third link 437 about the third axis 436a associated with the third joint 436. In the embodiment shown in FIG. 3, the first, second, and third axes 432a, 434a, and 436a are parallel (and, in this case, are all parallel to the X axis). In the embodiment shown in FIG. 3, the first, second, and third joints 432, 434, and 436 are all pitch joints.

In some embodiments, a robotic arm of a highly integrated mobile manipulator robot may include a different number of degrees of freedom than the robotic arms discussed above. Additionally, a robotic arm need not be limited to a robotic arm with three pitch joints and a 3-DOF wrist. A robotic arm of a highly integrated mobile manipulator robot may include any suitable number of joints of any suitable type, whether revolute or prismatic. Revolute joints need not be oriented as pitch joints, but rather may be pitch, roll, yaw, or any other suitable type of joint.

Returning to FIG. 3, the robotic arm 430 includes a wrist 438. As noted above, the wrist 438 is a 3-DOF wrist, and in some embodiments may be a spherical 3-DOF wrist. The wrist 438 is coupled to a distal portion of the third link 437. The wrist 438 includes three actuators configured to rotate an end effector 450 coupled to a distal portion of the wrist 438 about three mutually perpendicular axes. Specifically, the wrist may include a first wrist actuator configured to rotate the end effector relative to a distal link of the arm (e.g., the third link 437) about a first wrist axis, a second wrist actuator configured to rotate the end effector relative to the distal link about a second wrist axis, and a third wrist actuator configured to rotate the end effector relative to the distal link about a third wrist axis. The first, second, and third wrist axes may be mutually perpendicular. In embodiments in which the wrist is a spherical wrist, the first, second, and third wrist axes may intersect.

In some embodiments, an end effector may be associated with one or more sensors. For example, a force/torque sensor may measure forces and/or torques (e.g., wrenches) applied to the end effector. Alternatively or additionally, a sensor may measure wrenches applied to a wrist of the robotic arm by the end effector (and, for example, an object grasped by the end effector) as the object is manipulated. Signals from these (or other) sensors may be used during mass estimation and/or path planning operations. In some embodiments, sensors associated with an end effector may include an integrated force/torque sensor, such as a 6-axis force/torque sensor. In some embodiments, separate sensors (e.g., separate force and torque sensors) may be employed. Some embodiments may include only force sensors (e.g., uniaxial force sensors, or multi-axis force sensors), and some embodiments may include only torque sensors. In some embodiments, an end effector may be associated with a custom sensing arrangement. For example, one or more sensors (e.g., one or more uniaxial sensors) may be arranged to enable sensing of forces and/or torques along multiple axes. An end effector (or another portion of the robotic arm) may additionally include any appropriate number or configuration of cameras, distance sensors, pressure sensors, light sensors, or any other suitable sensors, whether related to sensing characteristics of the payload or otherwise, as the disclosure is not limited in this regard.

As discussed above, accurate estimation of the pose (location and orientation) of an object to be grasped by a robotic device is important to enable the robotic device to position its gripper properly to grasp the object without colliding with other objects in the environment. A robotic device used in accordance with the techniques described herein may include one or more camera modules, each of which includes at least one two-dimensional (2D) camera (e.g., a color camera, such as an RGB camera) and a depth sensor. Object features detected in image(s) captured by the 2D camera(s) may be projected into 3D space using depth information sensed by the depth sensor to generate an estimated pose of the object. Errors in pose estimation of objects in the environment may be due to inaccurate feature detection, erroneous depth information, or combination of both.

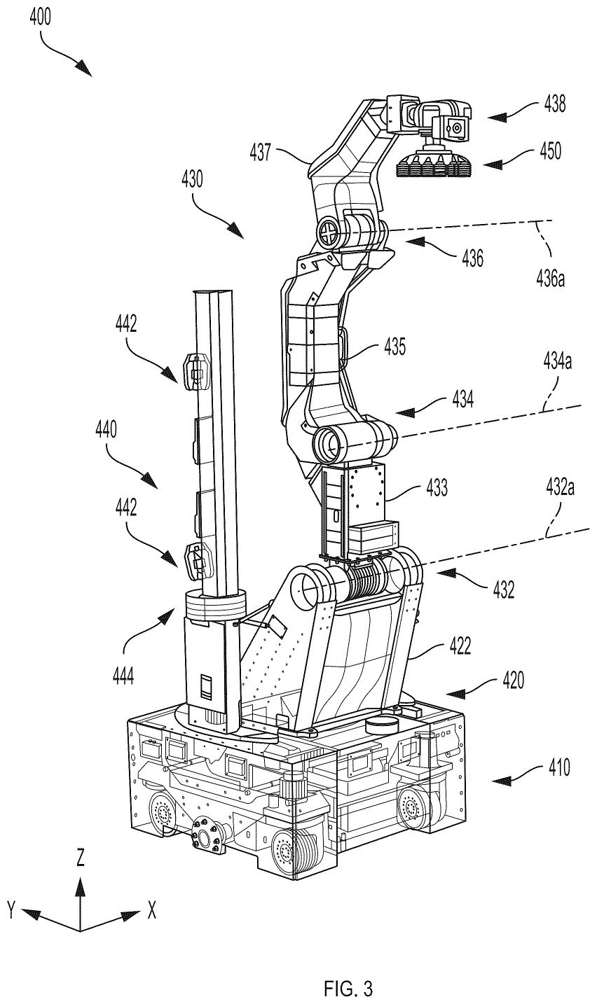

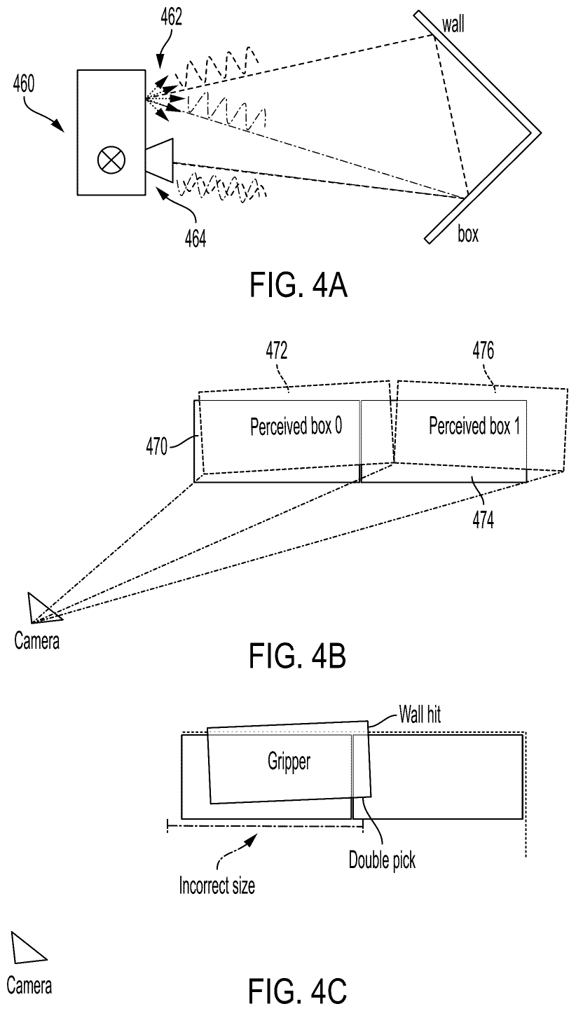

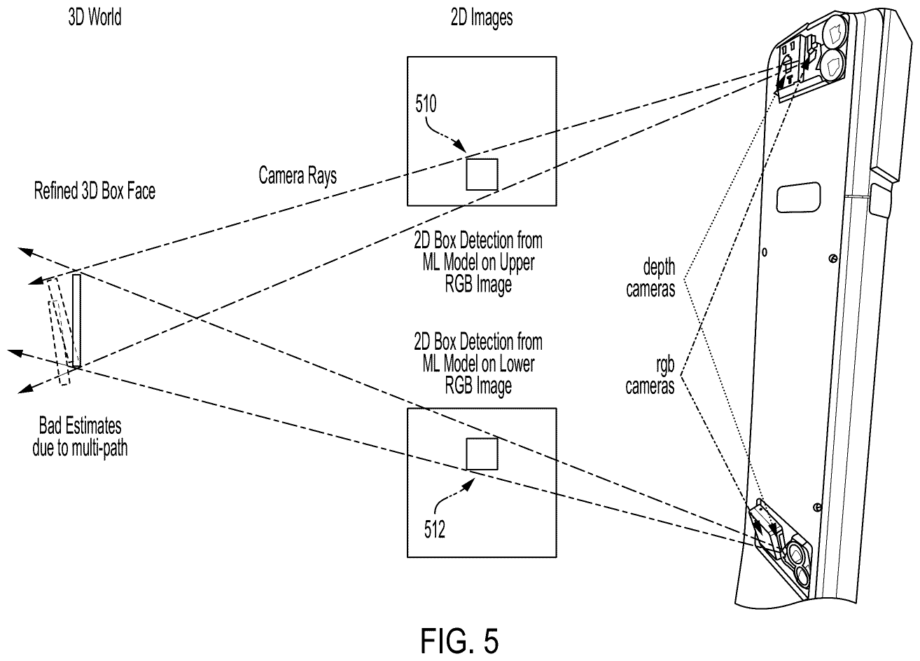

In environments that include multiple interacting surfaces, such as the interior of a truck, depth information sensed using indirect time-of-flight sensors may be distorted due to multi-path artifacts. FIG. 4A schematically illustrates how multi-path artifacts may arise in such an environment. As shown in FIG. 4A, an indirect time-of-flight sensor 460 includes an emitter 462 configured to emit an amplitude modulated signal into the environment and a detector 464 (e.g., a camera) configured to detect signals reflected by objects in the environment. The signal output by emitter 462 may be a cone of radiation that may be reflected by objects in the environment. The distance from the sensor 460 to a particular object in the environment may be determined based on a phase shift of the reflected signal compared to the emitted signal. When multiple interacting surfaces are present in the environment, an example of which is shown in FIG. 4A, the emitted signal may reflect off of multiple surfaces prior to returning to the detector 464. For instance, as shown in FIG. 4A, a first portion of the emitted signal may be reflected directly by a box in the environment and a second portion of the emitted signal may reflect off of a wall in the environment, then the box, prior to being reflected back to the detector 464. Accordingly, the signal sensed at the detector 464 is a mixture of signals with different phases having different (direct and indirect) reflection paths. As a result of this distortion in the sensed signal, the box may appear to be located at a farther distance than its actual location in the environment. More generally, multi-path artifacts warp the point cloud of objects in the environment, resulting in a poor understanding of the physical locations of the objects.

FIG. 4B schematically illustrates how an environment that causes multi-path artifacts may result in estimates of objects that are not aligned with their actual location in the environment. Due to multi-path artifacts, box 470 is perceived has having a pose 472 and box 474 is perceived as having a pose 476. FIG. 4C illustrates some examples of problems that may occur due to the inaccurate estimate of the pose of box 470 in the example of FIG. 4B. As described above, a robot configured to grasp objects may attempt to place its gripper in contact with or near the face of the object that is to be grasped. If the perception system of the robot estimates that the object to be grasped is located in a different pose than its actual pose in the environment, the robot may position the gripper in a sub-optimal position to grasp the object. For example, as shown in FIG. 4C, the gripper may be placed over multiple objects, resulting in an unintentional double pick of multiple objects. Additionally, if a wall is located behind the target object (e.g., box 470) the gripper may collide with the wall when positioning the gripper to grasp the target object. The incorrect estimated pose of the target object due to multi-path effects may also result in an incorrect size measurement of the target object, which may result in improper positioning of the gripper leading to inadequate suction when a grasp of the target object is attempted.

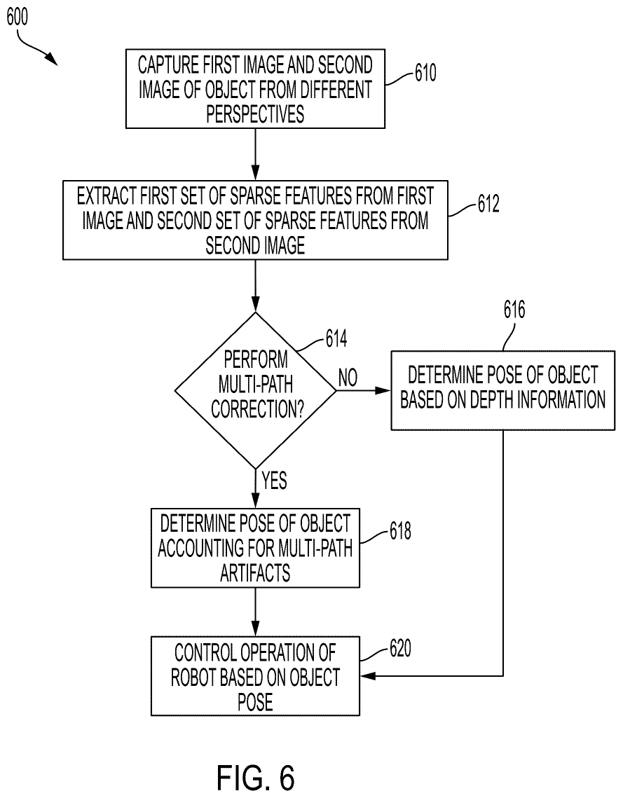

To mitigate, at least in part, the effect of multi-path artifacts on object pose estimation, some embodiments of the present disclosure use triangulation of sparse 2D features to reconstruct an estimate of the object pose. FIG. 5 schematically illustrates a mast of a robotic device that includes an upper camera module and a lower camera module. Each of the upper and lower camera modules includes at least one 2D camera (e.g., a red-green-blue (RGB) camera) and at least one depth sensor (e.g., an indirect time-of-flight camera). The upper and lower camera modules have overlapping fields of view, such that both camera modules may capture images that include the same object (e.g., a target object). In some embodiments, the target object is located at distance 1-5 times the distance between the two cameras (e.g., the baseline between the upper and lower cameras). By contrast, some conventional dense stereo cameras may be configured to measure objects at a distance 5-200 times the baseline. In the example shown in FIG. 5, the target object is a box having a square face, though it should be appreciated that the pose of any suitable object may be detected using the techniques described herein.

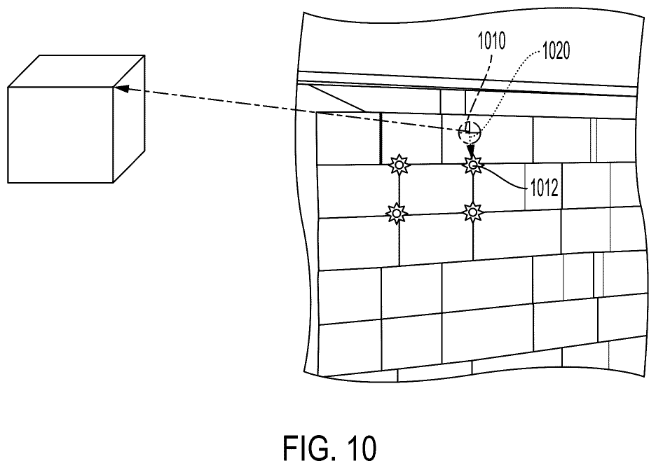

As shown in FIG. 5, the 2D images captured by the upper and lower camera modules may be processed to detect the object in each image. In some embodiments, the images are processed using one or more computer vision techniques to detect features associated with the object. Examples of such techniques include, but are not limited to using a scale-invariant feature transform (SIFT) or using a oriented FAST and rotated BRIEF (ORB) feature detection process. In some embodiments, the images are processed by a trained machine learning model to detect features associated with the object. For instance, the features associated with the object may be corners of the face of the box. Due to the different perspective of the environment captured by the two camera modules, the object appears at different locations in the 2D images. In the upper camera image, the target object is located at position 510 in the image, whereas in the lower camera image, the same target object is located at position 512 in the image. To determine the pose of the target object, the 2D detection of the target object in each image is projected into 3D space using the depth information sensed by the corresponding depth sensor. As shown in FIG. 5, due to multi-path artifacts introduced in the depth measurements, the estimates of the object pose are not accurate. In some embodiments, the initial pose estimates and the camera rays from the 2D cameras in the camera modules may be used to correct for multi-path artifacts to determine a refined pose estimate for the object. For example, as schematically illustrated in FIG. 5, the camera rays of the upper and lower camera modules intersect at a location where the refined pose estimate may be determined. An example technique for performing multi-path artifact correction in accordance with some embodiments of the present disclosure is described in more detail below in connection with FIG. 9.

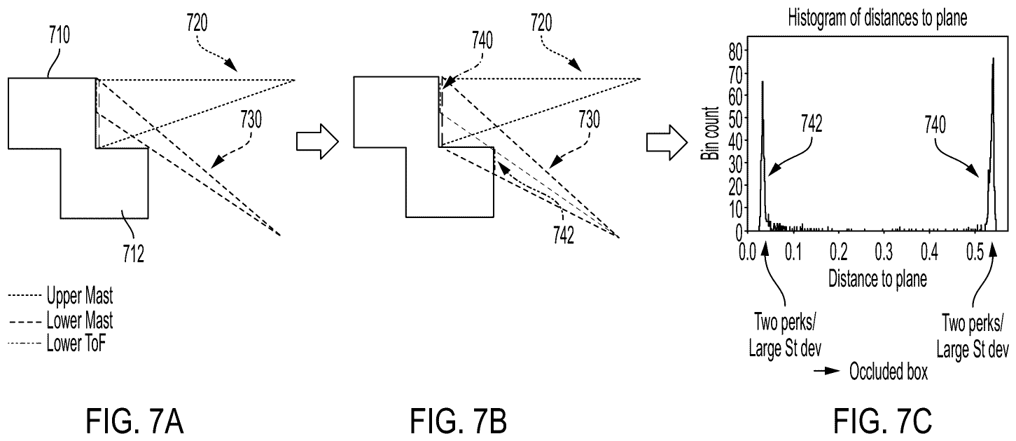

FIG. 6 illustrates a flowchart of a process 600 for determining a pose of an object in the environment of a robot, in accordance with some embodiments of the present disclosure. Process 600 begins in act 610, where a first image and a second image of an object in the environment are captured. In the example of FIG. 5 the first and second images are captured by different cameras located on a mast of a robotic device. It should be appreciated, however, that in some embodiments, the first and second images may be captured by the same camera provided that the perspectives of the object in the two images is different, and assuming that the objects in the scene remain static between the first and second image captures. In further embodiments, multiple images captured from more than two cameras may be used. In yet further embodiments, multiple images from a first camera having different perspectives and one or more images from a second camera may be used together, in accordance with the techniques described herein. When two cameras are used to capture the first and second images, the fields-of-view of the two cameras should overlap to ensure that the object is observable in both images.

Process 600 then proceeds to act 612, where a first set of sparse features associated with the object is extracted from the first image and a second set of sparse features associated with the object is extracted from the second object, wherein the first set and second set include matching features (e.g., both the first and second set of sparse features include the location of four corners of the same box face in the respective first and second images). For instance, the first and second sets of sparse features may be determined by a processor of a camera system that capture the first and second images. Such a processor may be part of the same camera system (e.g., integrated with the camera system) in communication with the camera system, or otherwise be associated with the camera system. In some embodiments, the first and second images are provided as input to a trained machine learning model, and the first set of sparse features and second set of sparse features are provided as output of the trained machine learning model. Although corners of a box face are used as an example herein of sparse features that are extracted from images, it should be appreciated that any other distinguishing features of the target object including, but not limited to, edges, distinctive markings, etc., may alternatively be used as extracted sparse features in the first set and second set.

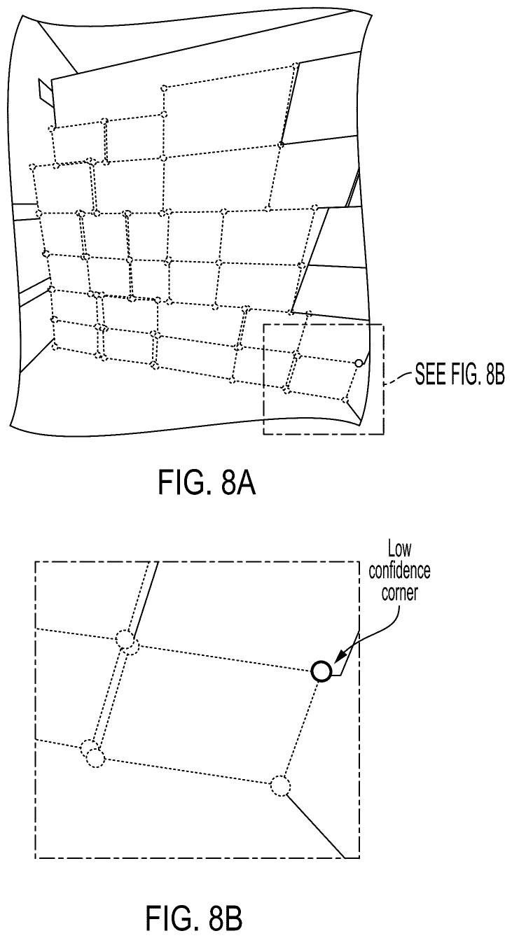

Process 600 then proceeds to act 614, where it is determined whether to perform multi-path correction. The inventors have recognized and appreciated that it may be helpful only to perform multi-path correction of an pose estimate for an object using one or more of the techniques described herein when certain conditions are met. For example, when there is poor correspondence between the extracted sparse features in the two images, it may not be helpful to perform multi-path correction. For instance, if the object is partially occluded in one of the images such that at least some of the sparse features (e.g., the corners of a box face) are not detectable in the image, it may be determined in act 614 not to perform multi-path correction. An example technique for detecting occlusions is schematically illustrated in FIGS. 7A-7C, described in more detail below. In some embodiments, multi-path correction may be performed even in the scenario in which there is incomplete information (e.g., due to low confidence, partial occlusion, etc.) for at least some of the sparse features in one of the images.

Another criterion for determining whether to perform multi-path correction may be that each of the extracted sparse features has a confidence value above a threshold value. As described above, sparse features associated with an object in an image may be extracted by processing the image with a trained machine learning model. The output of the machine learning model may include a set of detected features (e.g., box corners) and an associated confidence value for each of the detected features. When at least one of the sparse features extracted in the first or second image is associated with a confidence value below a threshold value, it may be determined not to perform multi-path correction in act 614 due to the uncertainty associated with the extracted feature. In some embodiments, measurements of uncertainty associated with an extracted feature other than comparing a confidence value with a threshold value may be used. For instance, an average error and standard deviation associated with an extracted feature value may be used to define a level of uncertainty associated with the extracted feature.

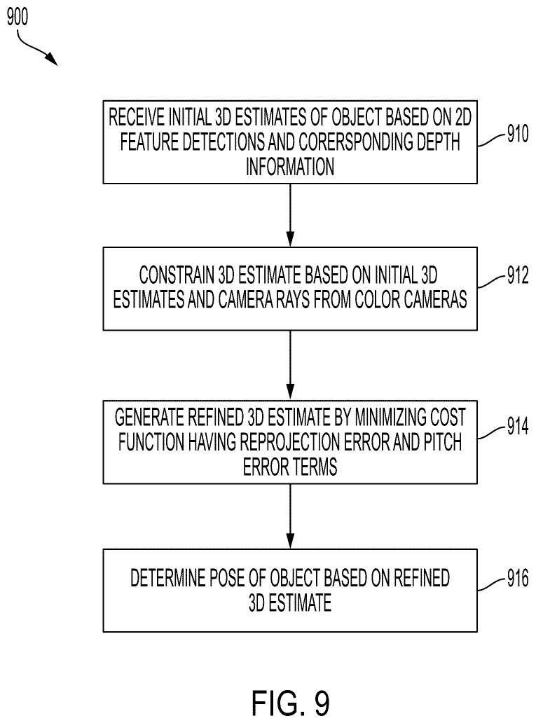

FIG. 8A illustrates an example of an annotated image output from a machine learning model trained to detect box faces. In the example of FIG. 8A, the sparse features may be the corners of each of the box faces detected in the image. Each of the box corners may be associated with a confidence value indicating a confidence that the model has correctly identified the box corner. As shown in FIG. 8B, some box corners may be identified, but with low confidence (e.g., confidence less than a threshold value). In such a situation, it may be determined in act 614 of process 600 not to perform multi-path correction for the box face associated with the low confidence corner.

In some embodiments in which box face corners are detected by the perception system of the robotic device, it may not be necessary to detect all four corners of the box face with high confidence to be able to perform multi-path correction. For instance, if three of the corners are detected with high confidence, the plane corresponding to the box face may be determined from the three detected corners. In another example, if only two of the corners are detected with high confidence with the remaining two corners being detected with low confidence, it may be possible to use other information (e.g., a normal vector determined from measured depth information) to define the plane of the box face despite the missing feature information. In such instances, it may be possible to perform multi-path correction using one or more of the techniques described herein.

Returning to process 600, if it is determined in act 614 that multi-path correction should not be performed, process 600 proceeds to act 616, where the pose of the object is determined based, at least in part, on the depth information (e.g., from the time-of-flight sensor), without performing multi-path correction. In some embodiments, when it is determined in act 614 not to perform multi-path correction because of low confidence values for detected features and/or due to an occlusion of the object in one of the images, the image without the occlusion and/or the low confidence value feature detection may be used in act 616 for estimating the pose of the object.

When it is determined in act 614 to perform multi-path correction (e.g., because all of the conditions for performing multi-path correction have been satisfied), process 600 proceeds to act 618, where the pose of the object is determined using multi-path correction according to one or more of the techniques described herein. After the pose of the object is determined in either act 616 or act 618, process 600 proceeds to act 620, where an operation of the robot is controlled based on the determined object pose. For example, the robot may be controlled to position its gripper in contact with or near the surface of the object prior to grasping the object.

FIGS. 7A-7C schematically illustrate a process for detecting occlusions of features of an object in an image, in accordance with some embodiments of the present disclosure. As described herein, a robot may have multiple camera modules arranged thereon, each of which includes a 2D camera configured to capture an image of the robot's environment from different perspectives and a depth sensor configured to determine depth information that can be mapped to the pixels in the corresponding 2D image. In the example configuration shown in FIG. 7A, the robot includes an “upper mast” camera module and a “lower mast” camera module configured to capture images of a stack of boxes that includes upper box 710 and lower box 712 arranged below upper box 710. When attempting to determine features of the upper box 710 from the captured images, the upper mast camera may have a field of view 720 that captures the entire front face of upper box 710, whereas the lower mast camera may have a field of view 730 that captures only a portion of the front face of upper box 710 due to an occlusion caused by lower box 712. In some embodiments of the present disclosure, the occlusion caused by lower box 712 in the scenario shown in FIG. 7A may be identified based, at least in part, on the depth information associated with the lower mast camera module. As shown in FIG. 7B, in the situation where there is an occlusion, the depth information may include first depth information 740 associated with detection of the front face of the upper box 710 and second depth information 742 associated with detection of the front face of the lower box 712.

FIG. 7C illustrates a histogram of the depth information captured by the depth sensor of the lower mast camera module in the example scenario shown in FIG. 7B. In some embodiments, it may be determined that one of the images has an occlusion when an evaluation of the histogram of its corresponding depth sensor data has a bimodal distribution. As shown in FIG. 7C, the histogram has a bimodal distribution with a first peak corresponding to the first depth information 740 and a second peak corresponding to the second depth information 742. Determining that a histogram of measured depth information has a bimodal distribution may be performed in any suitable way. For instance, in some embodiments, the standard deviation of the depth information measurements may be determined, and when the standard deviation is above a threshold value, it may be determined that the histogram has a bimodal distribution. Consequently it may be determined that the corresponding image includes an occlusion. As described above, when an occlusion is detected in one of the images, it may be determined that a condition for performing multi-path correction is not satisfied, and a pose of the object may be determined without performing multi-path correction based on the depth information corresponding to the image that does not have an occlusion (the upper mast camera image in the example of FIG. 7A).

FIG. 9 illustrates a flowchart of a process 900 for performing multi-path correction to estimate a pose of an object, in accordance with some embodiments of the present disclosure. In describing process 900, the example of detecting box corners as sparse features in a 2D image to determine the pose of the box in the 3D environment of the robot is used. It should be appreciated however, that other sparse features and/or other types of objects may alternatively be used in accordance with process 900 to perform multi-path correction. For example, sparse features may include edges or other distinctive features of objects that can be matched across multiple images having different perspectives.

Process 900 begins in act 910, where initial 3D estimates of the object based on the 2D sparse feature detections and the corresponding depth information are received. As described herein, a pose of an object in a 3D environment may be determined by detecting sparse features of the object (e.g., the four corners of a box face) in a 2D image and projecting the sparse features into a 3D representation based on depth information that may be used to map a distance in the environment to each of the pixels corresponding to the sparse features. When the environment includes surfaces that cause multi-path artifacts in the depth information measurements, the 3D representation may be corrected or “refined” using one or more of the techniques described herein. In act 910, the initial 3D estimates may include the poses of a box face for each of the two images captured from different perspectives. In this example, each of the initial 3D estimates may be a rectangle that corresponds to a box face oriented in 3D space.

Process 900 then proceeds to at 912, where the solution space for the 3D estimate is constrained based on the initial 3D estimates and the camera rays from the 2D cameras, as shown schematically in FIG. 5. Process 900 then proceeds to act 914, where a refined 3D estimate for the object is generated by performing an optimization that minimizes a cost function for different types of errors. For instance, the cost function may include a reprojection error and a pitch error in the 3D environment, and the optimization may be configured to minimize one or both of those errors. In some embodiments, the optimization is a least-squares optimization.

With regard to the pitch error, the inventors have recognized that slight pitch errors in the initial 3D pose estimate may occur, for example, due to small inaccuracies in the location of the sparse feature detections from the images and/or errors in the calibration between the first and second (e.g., upper and lower) cameras. Accordingly, in some embodiments, the pitch error term in the cost function may correct small pitch errors (e.g., 1 or a few degrees of pitch in the 3D environment) to a 0° pitch (i.e., parallel to the floor) based on the assumption that most objects are not pitch significantly relative to the floor plane. In some embodiments, to account for some outlier rejection, an arctan cost function may be used to minimize the pitch error. For example, an arctan cost function may output a linear cost for small pitch errors and a fixed cost otherwise.

With regard to the reprojection error, each sparse feature represented in the 3D pose estimate may be reprojected back into 2D image space. For example, when performing box face detection using box corners, each of the 8 corners of the box that have been projected into 3D space to determine the initial 3D pose estimates may be reprojected back into image space, and the distances between the detected location of each box corner in 2D image space and the reprojected location of the corresponding box corner may be minimized (e.g., using least squares optimization).

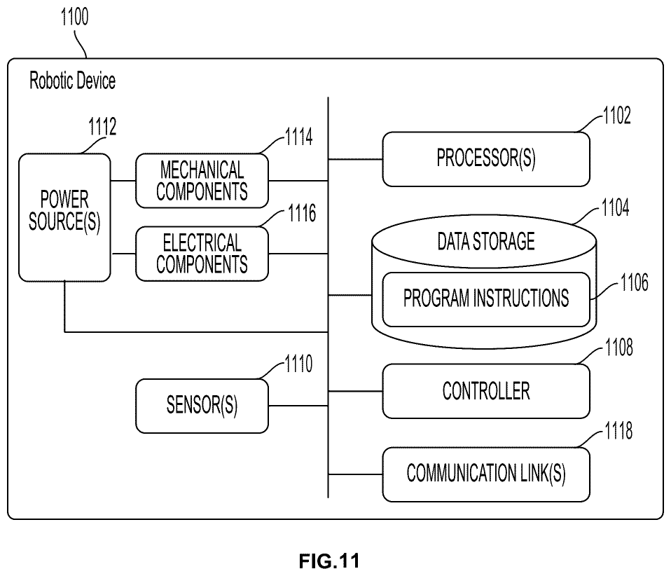

Because the two captured images of the box have different perspectives, the reprojection of the box corners back into image space may differ by some distance from the box corners detected in image space when multi-path effects are present in the depth information used for the projection and reprojection to/from 3D space. For example, FIG. 10 shows a reprojected location 1010 for the upper right corner of a box face being separated from the detected location 1012 for the upper right corner of the box face by a distance. The length of the vector 1020 for the projected corner (e.g., location 1010) to the detected corner (e.g., location 1012) may represent the cost for that projection. Reprojecting each of the four corners of a box face into image space results in eight corresponding distances (e.g., d₁, d₂, . . . d₈) that can be minimized in the cost function during optimization. In some embodiments, rather than using the length of the vector connecting the reprojected and detected point of the sparse feature to represent the cost of a reprojection, the Ax and Ay coordinates comparing the reprojected and detected point of the sparse feature may represent two costs for the feature, resulting in 16 total reprojection errors to be minimized during optimization. In some embodiments, to account for some outlier rejection, an arctan cost function may be used to minimize the reprojection error. For example, an arctan cost function may output a linear cost for small reprojection errors and a fixed cost otherwise.

After performing optimization to generate the refined 3D estimate, process 900 proceeds to act 916, where the pose of the object is determined based on the refined 3D estimate. For example, the output of the optimization may be a rectangle in 3D space of a box face that has a particular orientation and pitch, where the pose has been corrected for multi-path artifacts introduced in the measured depth information. The determined pose of the object may be used to control an operation of the robot as described in connection with process 600 illustrated in FIG. 6.

In some embodiments, multi-path correction may be performed in some scenarios when there is a partial occlusion in one or both of the images captured by the camera modules of a mobile robot (e.g., the upper mast camera module and the lower mast camera modules shown in the example of FIG. 5). Despite the partial occlusion in an image, some embodiments may use valid information about sparse features (e.g., information about valid corners) extracted from the image to perform multi-path correction using one or more of the techniques described herein rather than simply ignoring the image with the partial occlusion.

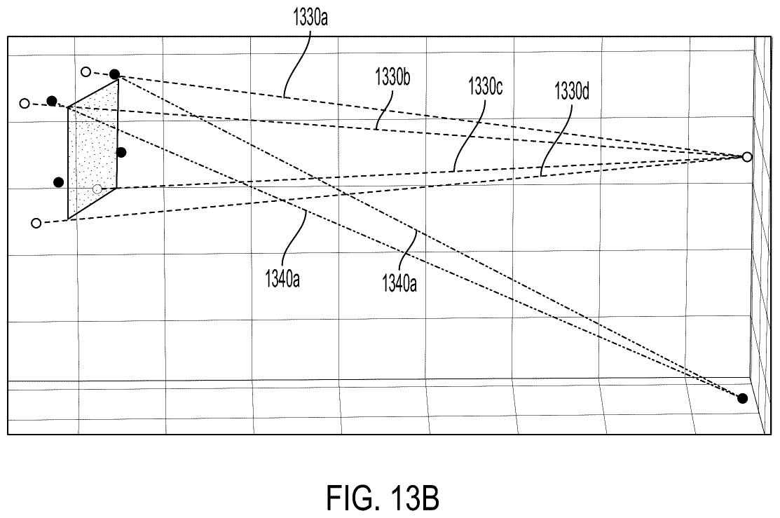

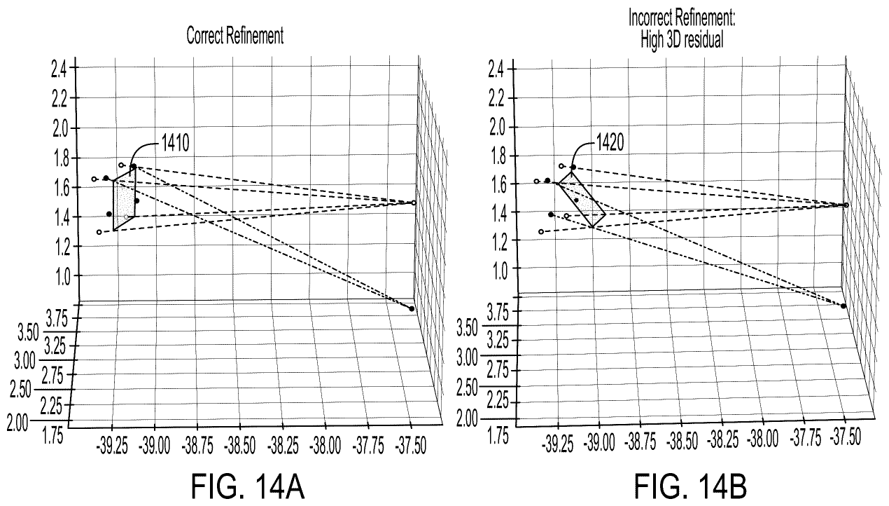

FIG. 12 illustrates a flowchart of a process 1200 for performing a multi-path correction process using incomplete sparse feature information, in accordance with some embodiments. Process 1200 begins in act 1210, where object pose optimizations (e.g., act 914 of process 900) are performed using different valid combinations of sparse features. For example, as described above, each optimization may minimize a cost function for different types of errors including a reprojection error and a pitch error in the 3D environment. FIG. 13A schematically illustrates a scenario in which two corners of a box face are occluded in one of the captured 2D images. In such a scenario, the total number of optimization sets may be 37. In some embodiments, at least some of the possible optimizations may not performed (e.g., by not meeting certain criteria) and/or at least some of the optimizations may be performed in parallel to speed up the computations.

Process 1200 then proceeds to act 1212, where thresholds may be used to filter out combinations of sparse features. For example, combinations having a reprojection error that exceeds a first threshold value may be filtered out. In another example, combinations having a 3D sparse feature residual error greater than a second threshold value may be filtered out. After filtering, a set of acceptable combination candidates may be generated. Process 1200 then proceeds to act 1214, where the acceptable combination candidates in the set are ranked based on one or more heuristics (e.g., a linear combination of heuristics). Non-limiting examples of heuristics that may be used include, but are not limited to, degree of pitch/orientation change (with close to the initial position preferred), object size (larger object faces preferred), and number of sparse features used in the optimization (more features used preferred). The acceptable combination candidate with the highest rank may be used as the refined 3D estimate of the object pose (e.g., the output from act 914 in process 900).

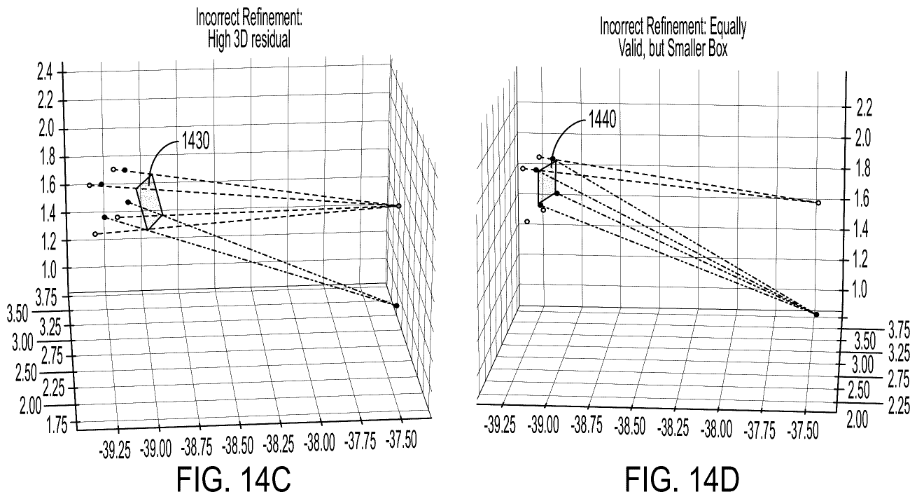

FIG. 13A schematically illustrates a scenario in which a perception system 1300 of a robot includes an upper camera module having a first field of view 1320 and a lower camera module having a second field of view 1322. In this scenario, the top two corners of upper object 1310 are detected in images captured by both the upper and lower camera modules, but the bottom two corners are only detected in an image captured by the upper camera and are not detected in an image captured by the lower camera due to a partial occlusion of the bottom corners by lower object 1312. FIG. 13B schematically illustrates that information associated with the rays corresponding to the detected corners of the upper object 1310 in the image from the upper camera module (i.e., rays 1330a, 1330b, 1330c, 1330d) and information associated with the rays corresponding to the detected corners of the upper object 1310 in the image from the lower camera module (i.e., rays 1340a, 1340b) may be used in an optimization to determine a combination candidate for the object face. FIGS. 14A-14D schematically illustrate object pose refinements using different combinations of corners of the upper object 1310 detected in the image from the lower camera module are used for optimization.

FIG. 14A corresponds to the scenario shown in FIG. 13B in which the upper two corners of the upper object 1310 as detected in the lower camera module image are used for optimization. As shown in FIG. 14A, the resulting object pose refinement 1410 is reasonably close to the initial position captured by the corners of the upper camera module. FIG. 14B corresponds to the scenario in which the left upper corner and another left point (e.g., caused by the occlusion) associated with the image from the lower camera module are used for optimization. As shown, the resulting object pose refinement 1420 is pitched considerably from the initial position. FIG. 14C corresponds to the scenario in which two lower points (e.g., caused by the occlusion) associated with the image from the lower camera module are used for optimization. As shown, the resulting object pose refinement 1430 is pitched considerably from the initial position. FIG. 14D corresponds to the scenario in which the two lower points (e.g., caused by the occlusion) used in the scenario of FIG. 14C and the two upper points used in the scenario of FIG. 14A associated with the image from the lower camera module are used for optimization. As shown, the resulting object pose refinement 1440 is pitched similarly to the initial position, although the size of the object face is smaller than the object pose refinement 1410 shown in FIG. 14A. Given the four object pose refinements 1410, 1420, 1430, 1440, they may be ranked relative to the initial position (e.g., according to act 1214 of process 1200), with object pose refinement 1410 being assigned the highest rank. The object pose refinement 1410 may then be used to determine the object pose (e.g., according to act 916 of process 900), as described herein.

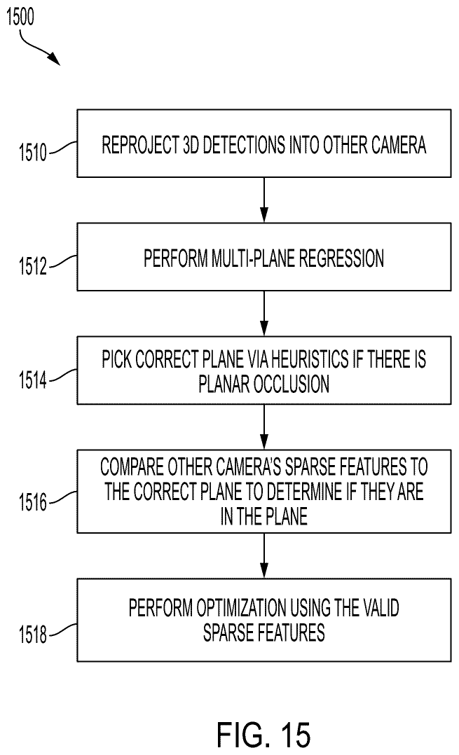

FIG. 15 illustrates a flowchart of an alternate process 1500 for performing a multi-path correction process using incomplete sparse feature information, in accordance with some embodiments. Process 1500 begins in act 1510, where 3D detections of sparse features for one camera are reprojected into the other camera (e.g., the detections of the corners for the upper camera are reprojected into the lower camera space). Process 1500 then proceeds to act 1512, where multi-plane regression is performed to determine if there is planar occlusion in one of the images. Process 1500 then proceeds to act 1514, where the correct plane is selected via one or more heuristics (e.g., planes further away from the camera modules may be preferred) if there is planar occlusion detected in act 1512. Process 1500 then proceeds to act 1516, where the other camera's sparse features (e.g., corners) are compared to the correct plane determined in act 1514 to determine whether those sparse features fall within the plane. Process 1516 then proceeds to act 1516, where the valid sparse features (e.g., corners falling within the plane) are used for optimization (e.g., in act 914 of process 900).

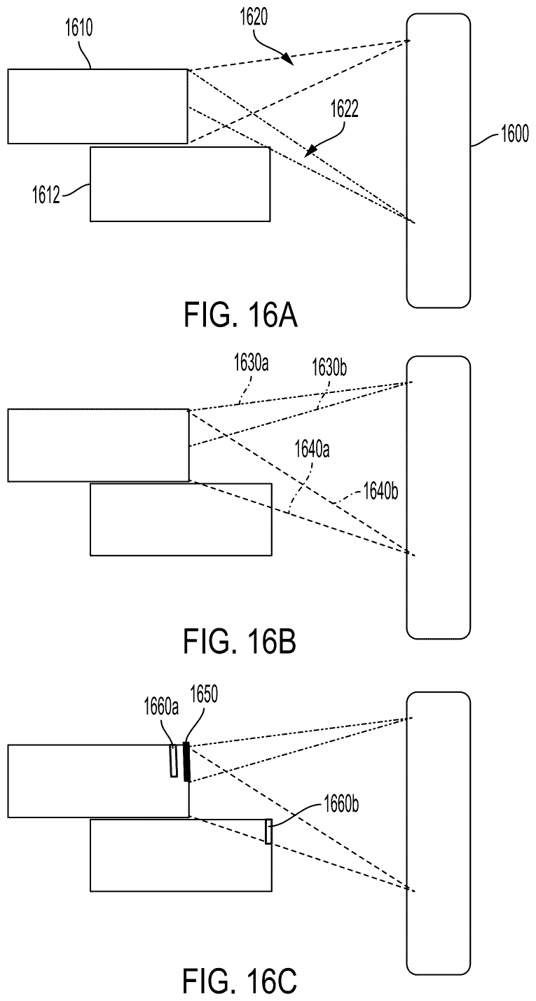

FIGS. 16A-16C schematically illustrates the acts in process 1500. FIG. 16A schematically illustrates a scenario in which a perception system 1600 of a robot includes an upper camera module having a first field of view 1620 and a lower camera module having a second field of view 1622. In this scenario, the top two corners of upper object 1610 are detected in images captured by both the upper and lower camera modules, but the bottom two corners are only detected in an image captured by the upper camera and are not detected in an image captured by the lower camera due to a partial occlusion of the bottom corners by lower object 1612. FIG. 16B schematically illustrates reprojecting the two detections 1630a, 1630b from the image captured by the lower camera module into the upper camera module space and reprojecting the two detections 1640a, 1640b from the image captured by the upper camera module into the lower camera module space (act 1510 of process 1500).

FIG. 16C schematically illustrates performing a multi-plane regression based on the reprojections (act 1512 of process 1500). As shown in FIG. 16B, the reprojection of the detections 1630a and 1630b into the upper camera module space results in a plane 1650, whereas the reprojection of the detections 1640a and 1640 into the lower camera module space results in a first plane 1660a and a second plane 1660b (reflecting the occlusion of the lower box in the lower camera module image. Due to the presence of plane 1660b, a planar occlusion is detected, and a correct plane (e.g., plane 1650) is selected (e.g., based on one or more heuristics). It may be determined that the upper sparse features (e.g., upper corners) of the upper object are detected in the image from the lower camera module by determining that those sparse features fall within the plane (or nearly fall within the plane based on some distance threshold). Those two sparse features in addition to the sparse features detected from the upper camera module image may then be used for optimization (e.g., in act 914 of process 900).

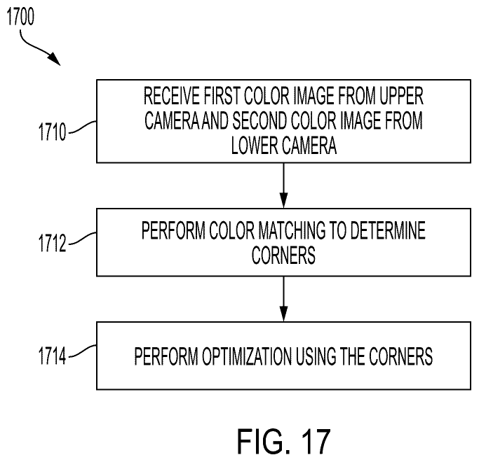

FIG. 17 illustrates a flowchart of an alternate process 1700 for performing a multi-path correction process using incomplete sparse feature information when the captured images are color images (e.g., RGB images), in accordance with some embodiments. Process 1700 begins in act 1710, where a first color image is received from the upper camera module (or a camera module having a first perspective) and a second color image is received from the lower camera module (or a camera module have a second perspective). Process 1700 then proceeds to act 1712, where color matching is performed to determine the corners that are present in both color images. Process 1700 then proceeds to act 1714, where the corners detected in both images determined based on the color matching are used for optimization (e.g., in act 914 of process 900).

Although three different techniques are described herein for performing a multi-path correction process using incomplete sparse feature information, it should be appreciated that in some embodiments, a combination of any two or more of these processes may alternatively be used. For instance, more robust thresholds may be able to be used to determine occlusion if multiple techniques are used together.

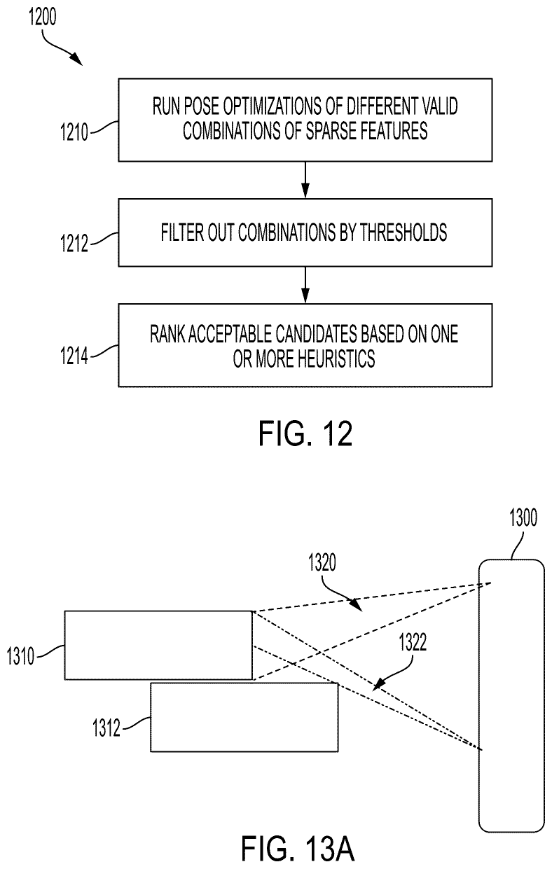

FIG. 11 illustrates an example configuration of a robotic device 1100, according to an illustrative embodiment of the invention. An example implementation involves a robotic device configured with at least one robotic limb, one or more sensors, and a processing system. The robotic limb may be an articulated robotic appendage including a number of members connected by joints. The robotic limb may also include a number of actuators (e.g., 2-5 actuators) coupled to the members of the limb that facilitate movement of the robotic limb through a range of motion limited by the joints connecting the members. The sensors may be configured to measure properties of the robotic device, such as angles of the joints, pressures within the actuators, joint torques, and/or positions, velocities, and/or accelerations of members of the robotic limb(s) at a given point in time. The sensors may also be configured to measure an orientation (e.g., a body orientation measurement) of the body of the robotic device (which may also be referred to herein as the “base” of the robotic device). Other example properties include the masses of various components of the robotic device, among other properties. The processing system of the robotic device may determine the angles of the joints of the robotic limb, either directly from angle sensor information or indirectly from other sensor information from which the joint angles can be calculated. The processing system may then estimate an orientation of the robotic device based on the sensed orientation of the base of the robotic device and the joint angles.

An orientation may herein refer to an angular position of an object. In some instances, an orientation may refer to an amount of rotation (e.g., in degrees or radians) about three axes. In some cases, an orientation of a robotic device may refer to the orientation of the robotic device with respect to a particular reference frame, such as the ground or a surface on which it stands. An orientation may describe the angular position using Euler angles, Tait-Bryan angles (also known as yaw, pitch, and roll angles), and/or Quaternions. In some instances, such as on a computer-readable medium, the orientation may be represented by an orientation matrix and/or an orientation quaternion, among other representations.

In some scenarios, measurements from sensors on the base of the robotic device may indicate that the robotic device is oriented in such a way and/or has a linear and/or angular velocity that requires control of one or more of the articulated appendages in order to maintain balance of the robotic device. In these scenarios, however, it may be the case that the limbs of the robotic device are oriented and/or moving such that balance control is not required. For example, the body of the robotic device may be tilted to the left, and sensors measuring the body's orientation may thus indicate a need to move limbs to balance the robotic device; however, one or more limbs of the robotic device may be extended to the right, causing the robotic device to be balanced despite the sensors on the base of the robotic device indicating otherwise. The limbs of a robotic device may apply a torque on the body of the robotic device and may also affect the robotic device's center of mass. Thus, orientation and angular velocity measurements of one portion of the robotic device may be an inaccurate representation of the orientation and angular velocity of the combination of the robotic device's body and limbs (which may be referred to herein as the “aggregate” orientation and angular velocity).

In some implementations, the processing system may be configured to estimate the aggregate orientation and/or angular velocity of the entire robotic device based on the sensed orientation of the base of the robotic device and the measured joint angles. The processing system has stored thereon a relationship between the joint angles of the robotic device and the extent to which the joint angles of the robotic device affect the orientation and/or angular velocity of the base of the robotic device. The relationship between the joint angles of the robotic device and the motion of the base of the robotic device may be determined based on the kinematics and mass properties of the limbs of the robotic devices. In other words, the relationship may specify the effects that the joint angles have on the aggregate orientation and/or angular velocity of the robotic device. Additionally, the processing system may be configured to determine components of the orientation and/or angular velocity of the robotic device caused by internal motion and components of the orientation and/or angular velocity of the robotic device caused by external motion. Further, the processing system may differentiate components of the aggregate orientation in order to determine the robotic device's aggregate yaw rate, pitch rate, and roll rate (which may be collectively referred to as the “aggregate angular velocity”).

In some implementations, the robotic device may also include a control system that is configured to control the robotic device on the basis of a simplified model of the robotic device. The control system may be configured to receive the estimated aggregate orientation and/or angular velocity of the robotic device, and subsequently control one or more jointed limbs of the robotic device to behave in a certain manner (e.g., maintain the balance of the robotic device).

In some implementations, the robotic device may include force sensors that measure or estimate the external forces (e.g., the force applied by a limb of the robotic device against the ground) along with kinematic sensors to measure the orientation of the limbs of the robotic device. The processing system may be configured to determine the robotic device's angular momentum based on information measured by the sensors. The control system may be configured with a feedback-based state observer that receives the measured angular momentum and the aggregate angular velocity, and provides a reduced-noise estimate of the angular momentum of the robotic device. The state observer may also receive measurements and/or estimates of torques or forces acting on the robotic device and use them, among other information, as a basis to determine the reduced-noise estimate of the angular momentum of the robotic device.

In some implementations, multiple relationships between the joint angles and their effect on the orientation and/or angular velocity of the base of the robotic device may be stored on the processing system. The processing system may select a particular relationship with which to determine the aggregate orientation and/or angular velocity based on the joint angles. For example, one relationship may be associated with a particular joint being between 0 and 90 degrees, and another relationship may be associated with the particular joint being between 91 and 180 degrees. The selected relationship may more accurately estimate the aggregate orientation of the robotic device than the other relationships.

In some implementations, the processing system may have stored thereon more than one relationship between the joint angles of the robotic device and the extent to which the joint angles of the robotic device affect the orientation and/or angular velocity of the base of the robotic device. Each relationship may correspond to one or more ranges of joint angle values (e.g., operating ranges). In some implementations, the robotic device may operate in one or more modes. A mode of operation may correspond to one or more of the joint angles being within a corresponding set of operating ranges. In these implementations, each mode of operation may correspond to a certain relationship.

The angular velocity of the robotic device may have multiple components describing the robotic device's orientation (e.g., rotational angles) along multiple planes. From the perspective of the robotic device, a rotational angle of the robotic device turned to the left or the right may be referred to herein as “yaw.” A rotational angle of the robotic device upwards or downwards may be referred to herein as “pitch.” A rotational angle of the robotic device tilted to the left or the right may be referred to herein as “roll.” Additionally, the rate of change of the yaw, pitch, and roll may be referred to herein as the “yaw rate,” the “pitch rate,” and the “roll rate,” respectively.

FIG. 11 illustrates an example configuration of a robotic device (or “robot”) 1100, according to an illustrative embodiment of the invention. The robotic device 1100 represents an example robotic device configured to perform the operations described herein. Additionally, the robotic device 1100 may be configured to operate autonomously, semi-autonomously, and/or using directions provided by user(s), and may exist in various forms, such as a humanoid robot, biped, quadruped, or other mobile robot, among other examples. Furthermore, the robotic device 1100 may also be referred to as a robotic system, mobile robot, or robot, among other designations.

As shown in FIG. 11, the robotic device 1100 includes processor(s) 1102, data storage 1104, program instructions 1106, controller 1108, sensor(s) 1110, power source(s) 1112, mechanical components 1114, and electrical components 1116. The robotic device 1100 is shown for illustration purposes and may include more or fewer components without departing from the scope of the disclosure herein. The various components of robotic device 1100 may be connected in any manner, including via electronic communication means, e.g., wired or wireless connections. Further, in some examples, components of the robotic device 1100 may be positioned on multiple distinct physical entities rather on a single physical entity. Other example illustrations of robotic device 1100 may exist as well.

Processor(s) 1102 may operate as one or more general-purpose processor or special purpose processors (e.g., digital signal processors, application specific integrated circuits, etc.). The processor(s) 1102 can be configured to execute computer-readable program instructions 1106 that are stored in the data storage 1104 and are executable to provide the operations of the robotic device 1100 described herein. For instance, the program instructions 1106 may be executable to provide operations of controller 1108, where the controller 1108 may be configured to cause activation and/or deactivation of the mechanical components 1114 and the electrical components 1116. The processor(s) 1102 may operate and enable the robotic device 1100 to perform various functions, including the functions described herein.

The data storage 1104 may exist as various types of storage media, such as a memory. For example, the data storage 1104 may include or take the form of one or more computer-readable storage media that can be read or accessed by processor(s) 1102. The one or more computer-readable storage media can include volatile and/or non-volatile storage components, such as optical, magnetic, organic or other memory or disc storage, which can be integrated in whole or in part with processor(s) 1102. In some implementations, the data storage 1104 can be implemented using a single physical device (e.g., one optical, magnetic, organic or other memory or disc storage unit), while in other implementations, the data storage 1104 can be implemented using two or more physical devices, which may communicate electronically (e.g., via wired or wireless communication). Further, in addition to the computer-readable program instructions 1106, the data storage 1104 may include additional data such as diagnostic data, among other possibilities.

The robotic device 1100 may include at least one controller 1108, which may interface with the robotic device 1100. The controller 1108 may serve as a link between portions of the robotic device 1100, such as a link between mechanical components 1114 and/or electrical components 1116. In some instances, the controller 1108 may serve as an interface between the robotic device 1100 and another computing device. Furthermore, the controller 1108 may serve as an interface between the robotic device 1100 and a user(s). The controller 1108 may include various components for communicating with the robotic device 1100, including one or more joysticks or buttons, among other features. The controller 1108 may perform other operations for the robotic device 1100 as well. Other examples of controllers may exist as well.

Additionally, the robotic device 1100 includes one or more sensor(s) 1110 such as force sensors, proximity sensors, motion sensors, load sensors, position sensors, touch sensors, depth sensors, ultrasonic range sensors, and/or infrared sensors, among other possibilities. The sensor(s) 1110 may provide sensor data to the processor(s) 1102 to allow for appropriate interaction of the robotic device 1100 with the environment as well as monitoring of operation of the systems of the robotic device 1100. The sensor data may be used in evaluation of various factors for activation and deactivation of mechanical components 1114 and electrical components 1116 by controller 1108 and/or a computing system of the robotic device 1100.

The sensor(s) 1110 may provide information indicative of the environment of the robotic device for the controller 1108 and/or computing system to use to determine operations for the robotic device 1100. For example, the sensor(s) 1110 may capture data corresponding to the terrain of the environment or location of nearby objects, which may assist with environment recognition and navigation, etc. In an example configuration, the robotic device 1100 may include a sensor system that may include a camera, RADAR, LIDAR, time-of-flight camera, global positioning system (GPS) transceiver, and/or other sensors for capturing information of the environment of the robotic device 1100. The sensor(s) 1110 may monitor the environment in real-time and detect obstacles, elements of the terrain, weather conditions, temperature, and/or other parameters of the environment for the robotic device 1100.

Further, the robotic device 1100 may include other sensor(s) 1110 configured to receive information indicative of the state of the robotic device 1100, including sensor(s) 1110 that may monitor the state of the various components of the robotic device 1100. The sensor(s) 1110 may measure activity of systems of the robotic device 1100 and receive information based on the operation of the various features of the robotic device 1100, such the operation of extendable legs, arms, or other mechanical and/or electrical features of the robotic device 1100. The sensor data provided by the sensors may enable the computing system of the robotic device 1100 to determine errors in operation as well as monitor overall functioning of components of the robotic device 1100.

For example, the computing system may use sensor data to determine the stability of the robotic device 1100 during operations as well as measurements related to power levels, communication activities, components that require repair, among other information. As an example configuration, the robotic device 1100 may include gyroscope(s), accelerometer(s), and/or other possible sensors to provide sensor data relating to the state of operation of the robotic device. Further, sensor(s) 1110 may also monitor the current state of a function that the robotic device 1100 may currently be operating. Additionally, the sensor(s) 1110 may measure a distance between a given robotic limb of a robotic device and a center of mass of the robotic device. Other example uses for the sensor(s) 1110 may exist as well.

Additionally, the robotic device 1100 may also include one or more power source(s) 1112 configured to supply power to various components of the robotic device 1100. Among possible power systems, the robotic device 1100 may include a hydraulic system, electrical system, batteries, and/or other types of power systems. As an example illustration, the robotic device 1100 may include one or more batteries configured to provide power to components via a wired and/or wireless connection. Within examples, components of the mechanical components 1114 and electrical components 1116 may each connect to a different power source or may be powered by the same power source. Components of the robotic device 1100 may connect to multiple power sources as well.

Within example configurations, any type of power source may be used to power the robotic device 1100, such as a gasoline and/or electric engine. Further, the power source(s) 1112 may charge using various types of charging, such as wired connections to an outside power source, wireless charging, combustion, or other examples. Other configurations may also be possible. Additionally, the robotic device 1100 may include a hydraulic system configured to provide power to the mechanical components 1114 using fluid power. Components of the robotic device 1100 may operate based on hydraulic fluid being transmitted throughout the hydraulic system to various hydraulic motors and hydraulic cylinders, for example. The hydraulic system of the robotic device 1100 may transfer a large amount of power through small tubes, flexible hoses, or other links between components of the robotic device 1100. Other power sources may be included within the robotic device 1100.

Mechanical components 1114 can represent hardware of the robotic device 1100 that may enable the robotic device 1100 to operate and perform physical functions. As a few examples, the robotic device 1100 may include actuator(s), extendable leg(s), arm(s), wheel(s), one or multiple structured bodies for housing the computing system or other components, and/or other mechanical components. The mechanical components 1114 may depend on the design of the robotic device 1100 and may also be based on the functions and/or tasks the robotic device 1100 may be configured to perform. As such, depending on the operation and functions of the robotic device 1100, different mechanical components 1114 may be available for the robotic device 1100 to utilize. In some examples, the robotic device 1100 may be configured to add and/or remove mechanical components 1114, which may involve assistance from a user and/or other robotic device.

The electrical components 1116 may include various components capable of processing, transferring, providing electrical charge or electric signals, for example. Among possible examples, the electrical components 1116 may include electrical wires, circuitry, and/or wireless communication transmitters and receivers to enable operations of the robotic device 1100. The electrical components 1116 may interwork with the mechanical components 1114 to enable the robotic device 1100 to perform various operations. The electrical components 1116 may be configured to provide power from the power source(s) 1112 to the various mechanical components 1114, for example. Further, the robotic device 1100 may include electric motors. Other examples of electrical components 1116 may exist as well.

In some implementations, the robotic device 1100 may also include communication link(s) 1118 configured to send and/or receive information. The communication link(s) 1118 may transmit data indicating the state of the various components of the robotic device 1100. For example, information read in by sensor(s) 1110 may be transmitted via the communication link(s) 1118 to a separate device. Other diagnostic information indicating the integrity or health of the power source(s) 1112, mechanical components 1114, electrical components 1116, processor(s) 1102, data storage 1104, and/or controller 1108 may be transmitted via the communication link(s) 1118 to an external communication device.

In some implementations, the robotic device 1100 may receive information at the communication link(s) 1118 that is processed by the processor(s) 1102. The received information may indicate data that is accessible by the processor(s) 1102 during execution of the program instructions 1106, for example. Further, the received information may change aspects of the controller 1108 that may affect the behavior of the mechanical components 1114 or the electrical components 1116. In some cases, the received information indicates a query requesting a particular piece of information (e.g., the operational state of one or more of the components of the robotic device 1100), and the processor(s) 1102 may subsequently transmit that particular piece of information back out the communication link(s) 1118.

In some cases, the communication link(s) 1118 include a wired connection. The robotic device 1100 may include one or more ports to interface the communication link(s) 1118 to an external device. The communication link(s) 1118 may include, in addition to or alternatively to the wired connection, a wireless connection. Some example wireless connections may utilize a cellular connection, such as CDMA, EVDO, GSM/GPRS, or 4G telecommunication, such as WiMAX or LTE. Alternatively or in addition, the wireless connection may utilize a Wi-Fi connection to transmit data to a wireless local area network (WLAN). In some implementations, the wireless connection may also communicate over an infrared link, radio, Bluetooth, or a near-field communication (NFC) device.

A number of implementations have been described. Nevertheless, it will be understood that various modifications may be made without departing from the spirit and scope of the disclosure.

1. A method of determining a pose of an object sensed by a camera system of a mobile robot, the method comprising:
acquiring, using the camera system, a first image of the object from a first perspective and a second image of the object from a second perspective; and
determining, by a processor of the camera system, a pose of the object based, at least in part, on a first set of sparse features associated with the object detected in the first image and a second set of sparse features associated with the object detected in the second image.

2. The method of claim 1, further comprising:
processing the first image and the second image with at least one machine learning model to detect the first set of sparse features and the second set of sparse features, respectively.

3. The method of claim 2, wherein
the at least one machine model is configured to output a location and a confidence value associated with each sparse feature in the first set and the second set, and
determining the pose of the object based, at least in part, on the first set of sparse features and the second set of sparse features is performed only when each sparse feature in the first set and the second set is associated with a confidence value above a threshold value.

4. The method of claim 1, wherein
the camera system includes a first camera module and second camera module, the first camera module and the second camera module being separated by a first distance and having overlapping fields-of-view,
the first image is acquired using the first camera module, and
the second image is acquired using the second camera module.

5. The method of claim 4, wherein
the first camera module includes a first depth sensor configured to acquire first depth information associated with the first image, and
the second camera module includes a second depth sensor configured to acquire second depth information associated with the second image.

6. The method of claim 5, wherein each of the first set of sparse features and the second set of sparse features include locations of a plurality of points associated with the object in the first image and the second image, respectively.

7. The method of claim 6, wherein the plurality of points associated with the object comprise a plurality of corners of the object.

8. The method of claim 7, wherein the object is a box and the plurality of points associated with the object comprise corners of a face of the box.

9. The method of claim 6, further comprising:
projecting the sparse features in the first set into a 3-dimensional (3D) space based on the first depth information to produce a first initial 3D estimate of the object; and
projecting the sparse features in the second set into the 3D space based on the second depth information to produce a second 3D estimate of the object.

10. The method of claim 9, further comprising:
generating a refined 3D estimate of the object based on the first initial 3D estimate, the second 3D estimate and a cost function that includes a plurality of error terms, the plurality of error terms including at least one reprojection error term.

11. The method of claim 10, wherein
each sparse feature in the first set and the second set has a detected location in 2D image space, and
generating the refined 3D estimate comprises:
reprojecting each sparse feature from the 3D space into the 2D image space to determine a corresponding reprojected location for each sparse feature; and
defining a vector from the reprojected location of each sparse feature to its corresponding detected location in 2D image space,
wherein the cost function includes a reprojection error term for each sparse feature corresponding to a length of the defined vector for the sparse feature.

12. The method of claim 10, wherein the plurality of error terms includes at least one pitch error term.

13. The method of claim 5, wherein each of the first depth sensor and the second depth sensor is an indirect time-of-flight sensor.

14. The method of claim 1, further comprising:
determining whether a location of at least one sparse feature in the first set is inaccurate due to an occlusion of the object by another object sensed by the camera system; and
determining the pose of the object based, at least in part, on the first set of sparse features and the second set of sparse features is performed only when it is not determined that the location of the at least one sparse feature in the first set is inaccurate due to an occlusion of the object by another object sensed by the camera system.

15. The method of claim 14, wherein determining whether a location of at least one sparse feature in the first set is inaccurate due to an occlusion of the object by another object sensed by the camera system comprises:
acquiring, using the camera system, depth information corresponding to the first image of the object; and
determining that the another object is causing an occlusion of the object in the first image when a histogram of values in the depth information has a bimodal distribution.

16. The method of claim 15, further comprising:
determining a standard deviation of the values of the depth information; and
determining that the histogram of the values in the depth information has a bimodal distribution when the standard deviation is greater than a threshold value.

17. The method of claim 1, further comprising:
determining whether a location of at least one sparse feature in the first set is inaccurate due to a partial occlusion of the object by another object sensed by the camera system; and
identifying one or more valid sparse features in the first set of sparse features, the one or more valid sparse features not being occluded in the first image,
wherein determining the pose of the object is further based, at least in part, on the one or more valid sparse features in the first set of sparse features and the second set of sparse features associated with the object detected in the second image.

18. The method of claim 17, wherein identifying the one or more valid sparse features comprises:
performing pose optimizations of different valid combinations of sparse features to determine combination candidates;
filtering the combination candidates based on one or more thresholds to generate one or more acceptable combination candidates;
ranking the acceptable candidates based on one or more heuristics; and
identifying the one or more valid sparse features based, at least in part, on the acceptable candidate having a highest rank.

19. A mobile robot, comprising:
a camera system; and
at least one processor programmed to:
control the camera system to capture a first image of an object in an environment of the mobile robot from a first perspective and capture a second image of the object from a second perspective; and
determine a pose of the object based, at least in part, on a first set of sparse features associated with the object detected in the first image and a second set of sparse features associated with the object detected in the second image.

20. A non-transitory computer readable medium encoded with a plurality of instructions that, when executed by a computer processor, perform a method, the method comprising:
receiving from a camera system, a first image of an object captured from a first perspective and a second image of the object captured from a second perspective; and
determining, by at least one processor of the camera system, a pose of the object based, at least in part, on a first set of sparse features associated with the object detected in the first image and a second set of sparse features associated with the object detected in the second image.
